(19) United States
(12) Patent Application Publication
(10) Pub. No.: US 2018/0317013 A1
(43) Pub. Date: Nov. 1, 2018

(54) INVERTED DOME FOR SPEAKER DRIVERS

(71) Applicant: Kimon Bellas, Camarillo, CA (US)

(72) Inventors: Kimon Bellas, Camarillo, CA (US); Alan Dwight Hulsebus, II, Simi Valley, CA (US)

(73) Assignee: Kimon Bellas, Camarillo, CA (US)

(21) Appl. No.: 15/498,264

(22) Filed: Apr. 26, 2017

(51) Int. Cl. H04R 7/12; H04R 9/06; H04R 31/00; H04R 7/18

(52) U.S. Cl. CPC H04R 7/127; H04R 7/18; H04R 31/003; H04R 9/06

(57) ABSTRACT

Devices and methods described herein can comprise novel and improved designs and layouts to optimize the structural integrity and efficiency in speaker drivers. Embodiments of the present disclosure can also include a speaker driver comprising novel and improved component design which can optimize the performance and specifications of the device. Embodiments according to the present disclosure can include novel inverted dome designs which can improve the structural integrity of the speaker driver. Dome designs can also provide strategic structural reinforcement devices. Embodiments herein can include dome edges which can bend back to form a type of trough to build a reinforcement ring with a negligible mass addition. In this manner, speaker drivers described herein can provide novel and improved features which simplify the manufacturing process, lower the manufacturing cost, and/or reduce the overall weight of the device.

### BACKGROUND

### Field

The present disclosure relates generally to audio transducers and/or speaker drivers, and more particularly to speaker drivers with novel and improved structural features and inverted dome designs.

### Description of the Related Art

Speaker drivers are a type of audio transducer that convert electrical audio signals to sound waves. Speaker drivers are commonly associated with specialized transducers, which can reproduce a portion of the audible frequency range. Speaker drivers are sometimes referred to as loudspeakers. A common type of speaker driver, often referred to as a dynamic or electrodynamic driver, converts electric current to sound waves via a coil of wire. This is widely known as a voice coil, which is often suspended between magnetic poles. During operation, a signal is delivered to the voice coil by means of electrical wires. The current flowing in the voice coil creates a magnetic field that causes a component, such as a diaphragm, to be forced in one direction or another. This force can move against a field established by magnetic gaps as the electrical signal varies.

The back-and-forth, oscillatory motion drives the air in the device, which results in pressure differentials that convert to sound waves. Put more succinctly, speaker drivers utilize electrical audio signals to drive air through controlled movement, which in turn results in sound output. To generate a wide range of sound, different speaker drivers can be utilized to each cover a portion of the range of desired frequencies.

Speaker drivers can use a diaphragm or cone that supports a voice coil, which can also be on a magnet. In some speaker drivers, the voice coil resides in a position within the magnetic gap. The voice coil can also be connected to a dome, such that movement of the dome is controlled by changes to the electrical signals. At lower audio frequencies, this dome can stay relatively rigid. However, at higher frequencies the center of the dome and the edge of the dome can move axially and radially, respectively, which can cause dome failure. Hence, the point of high frequency at which the dome fails is known as the break up frequency or mode, as it is the high frequency limit of the speaker driver.

The aforementioned dome failure is usually caused by a lack of radial yield strength to constrain the dome diameter from expanding and/or contracting. Softer materials, e.g. rubber, silk, polyester fabric, Kevlar, and Mylar, can cause the dome to collapse in the center because the material has insufficient bending stiffness and tensile yield strength. Harder dome materials, e.g. magnesium, aluminum, titanium, beryllium, diamond and carbon fiber, and paper, have stiff centers so their first resonance is caused by radial diameter expansion and/or contraction. Hard materials have very poor damping, so one solution can be to make the structure so stiff that resonance occurs at a frequency above human hearing.

In an attempt to solve the dome break up problems mentioned above, those in the art have used a number of different dome structure shapes. However, the dome edge is still subject to the radial tensile yield break up problems. These aforementioned issues continue to present structural and/or longevity problems for speaker drivers.

### SUMMARY

The present disclosure relates to novel and improved speaker drivers that optimize component and structural efficiency. Speaker drivers according to the present disclosure have an improved ability to increase the overall structural integrity of the device. The present disclosure also provides speaker drivers that can optimize the performance and specifications of components. Moreover, speaker drivers described herein can provide a novel and improved manner in which to simplify the manufacturing process, lower the manufacturing cost, and/or reduce the overall weight of the device.

Embodiments according to the present disclosure can improve the structural integrity of the speaker driver through a novel inverted dome design. Dome designs according to the present disclosure can include an edge design that enables the speaker driver to form strategic structural reinforcement devices. Embodiments herein can include inverted dome edges that bend back to form a type of trough which builds a reinforcement ring shape without introducing unnecessary mass. However, it is understood that any component in the speaker driver can utilize the novel and improved structural features described in the embodiments herein.

One embodiment according to the present disclosure includes a speaker driver comprising a dome, which comprises a dome center structure and a dome edge. The dome edge is angled differently from the dome center structure. Additionally, a trough can be formed at the intersection of the dome edge and the dome center structure. Moreover, a reinforcement ring can be on the trough.

Another embodiment according to the present disclosure includes a method of forming a speaker driver comprising constructing a dome, which comprises a dome center structure and a dome edge. The method can also bend the dome edge at an angle different from the dome center structure, which can form a trough at the intersection of the dome edge and the dome center structure. Additionally, the method can inject an adhesive in the trough, as well as harden the adhesive to form a reinforcement ring.

In yet another embodiment, the present disclosure can include a speaker driver comprising a reinforcement assembly, which comprises a dome including a dome center structure and a dome edge. The reinforcement assembly can also include a reinforcement ring on the dome, a front suspension on the dome, a voice coil on the dome, as well as a bobbin on the dome.

These and other further features and advantages of the disclosure would be apparent to those skilled in the art from the following detailed description, taken together with the accompanying drawings, in which:

### BRIEF DESCRIPTION OF THE DRAWINGS

FIG. 1A is a top side perspective view of one embodiment of a speaker driver according to the present disclosure;

FIG. 1B is a bottom side perspective view of the speaker driver in FIG. 1A;

FIG. 1C is a top view of the speaker driver in FIG. 1A;

FIG. 1D is a bottom view of the speaker driver in FIG. 1A;

FIG. 1E is a side view of the speaker driver in FIG. 1A;

FIG. 2A is an exploded perspective view of the speaker driver in FIG. 1A;

FIG. 2B is sectional cut-out view of the speaker driver in FIG. 1A;

FIG. 3 is a top side perspective view of one embodiment of a reinforcement assembly according to the present disclosure;

FIG. 4 is a side view of one embodiment of an inverted dome according to the present disclosure;

FIG. 5 is a top side perspective view of one embodiment of a reinforcement ring according to the present disclosure;

FIG. 6 is a top side perspective view of one embodiment of a front suspension according to the present disclosure;

FIG. 7 is a top side perspective view of one embodiment of a voice coil according to the present disclosure;

FIG. 8 is a top side perspective view of one embodiment of a bobbin according to the present disclosure;

FIG. 9 is a top side perspective view of one embodiment of a suspension ring according to the present disclosure;

FIG. 10 is a top side perspective view of one embodiment of a rear suspension according to the present disclosure;

FIG. 11 is a top side perspective view of one embodiment of a basket according to the present disclosure;

FIG. 12A is a top side perspective view of one embodiment of a grille according to the present disclosure;

FIG. 12B is a side view of the grille in FIG. 12A;

FIG. 13A is a top side perspective view of one embodiment of a motor assembly according to the present disclosure;

FIG. 13B is a top view of the motor assembly in FIG. 13A;

FIG. 14 is a top side perspective view of one embodiment of a base cup according to the present disclosure;

FIG. 15A is a top side perspective view of one embodiment of a magnet according to the present disclosure;

FIG. 15B is a top side perspective view of one segment of the magnet shown in FIG. 15A;

FIG. 16 is a top side perspective view of one embodiment of a Faraday ring according to the present disclosure;

FIG. 17A is a top side perspective view of one embodiment of a negative terminal board according to the present disclosure;

FIG. 17B is a top side perspective view of one embodiment of a positive terminal board according to the present disclosure;

FIG. 18A is a top side perspective view of another embodiment of a reinforcement assembly according to the present disclosure;

FIG. 18B is a side view of an inverted dome in the embodiment of FIG. 18A;

FIG. 18C is a top side perspective view of one embodiment of a reinforcement ring in the embodiment of FIG. 18A;

FIG. 18D is a top side perspective view of one embodiment of a front suspension in the embodiment of FIG. 18A;

FIG. 18E is a top side perspective view of one embodiment of a voice coil in the embodiment of FIG. 18A;

FIG. 18F is a top side perspective view of one embodiment of a bobbin in the embodiment of FIG. 18A;

FIG. 19A is a top side perspective view of another embodiment of a reinforcement assembly according to the present disclosure;

FIG. 19B is a side view of an inverted dome in the embodiment of FIG. 19A;

FIG. 19C is a top side perspective view of one embodiment of a reinforcement ring in the embodiment of FIG. 19A;

FIG. 19D is a top side perspective view of one embodiment of a front suspension in the embodiment of FIG. 19A;

FIG. 19E is a top side perspective view of one embodiment of a voice coil in the embodiment of FIG. 19A;

FIG. 19F is a top side perspective view of one embodiment of a bobbin in the embodiment of FIG. 19A;

FIG. 20A is a top side perspective view of another embodiment of a reinforcement assembly according to the present disclosure;

FIG. 20B is a side view of an inverted dome in the embodiment of FIG. 20A;

FIG. 20C is a top side perspective view of one embodiment of a reinforcement ring in the embodiment of FIG. 20A;

FIG. 20D is a top side perspective view of one embodiment of a front suspension in the embodiment of FIG. 20A;

FIG. 20E is a top side perspective view of one embodiment of a voice coil in the embodiment of FIG. 20A;

FIG. 20F is a top side perspective view of one embodiment of a bobbin in the embodiment of FIG. 20A;

FIG. 21A is a top side perspective view of another embodiment of a reinforcement assembly according to the present disclosure;

FIG. 21B is a side view of a dome suspension structure in the embodiment of FIG. 21A;

FIG. 21C is a top side perspective view of one embodiment of a reinforcement ring in the embodiment of FIG. 21A;

FIG. 21D is a top side perspective view of one embodiment of a voice coil in the embodiment of FIG. 21A; and

FIG. 21E is a top side perspective view of one embodiment of a bobbin in the embodiment of FIG. 21A.

### DETAILED DESCRIPTION

Devices and methods described herein can comprise novel and improved designs and layouts to optimize the structural integrity and efficiency in speaker drivers. Embodiments of the present disclosure can also include a speaker driver comprising novel and improved component design which can optimize the performance and specifications of the device. Embodiments according to the present disclosure can include novel inverted dome designs which can improve the structural integrity of the speaker driver. Dome designs can also provide strategic structural reinforcement devices. Embodiments herein can include dome edges which can bend back to form a type of trough to build a reinforcement ring with a negligible mass addition. In this manner, speaker drivers described herein can provide novel and improved features which simplify the manufacturing process, lower the manufacturing cost, and/or reduce the overall weight of the device.

Speaker drivers according to the present disclosure are described herein as being utilized with headphones and/or speakers. However, it is understood that speaker drivers according to the present disclosure can be used in a wide variety of audio devices, including but not limited to headphones, microphones, hearing aids, in-ear monitors, micro speakers, tweeters, midrange speakers, woofers, and/or subwoofers. Moreover, speaker drivers according to the present disclosure can be used in any appropriate device or transducer application, such as motors, actuators, sensors, or any similar application.

Throughout this disclosure, the preferred embodiment and examples illustrated should be considered as exemplars, rather than as limitations on the present disclosure. As used herein, the term “invention,” “device,” “apparatus,” “method,” “disclosure,” “present invention,” “present device,” “present apparatus,” “present method” or “present disclosure” refers to any one of the embodiments of the disclosure described herein, and any equivalents. Furthermore, reference to various feature(s) of the “invention,” “device,” “apparatus,” “method,” “disclosure,” “present invention,” “present device,” “present apparatus,” “present method” or “present disclosure” throughout this document does not mean that all claimed embodiments or methods must include the referenced feature(s).

It is also understood that when an element or feature is referred to as being “on” or “adjacent” to another element or feature, it can be directly on or adjacent the other element or feature or intervening elements or features may also be present. In contrast, when an element is referred to as being “directly on” or extending “directly onto” another element, there are no intervening elements present. Additionally, it is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Furthermore, relative terms such as “inner,” “outer,” “upper,” “top,” “above,” “lower,” “bottom,” “beneath,” “below,” and similar terms, may be used herein to describe a relationship of one element to another. Terms such as “higher,” “lower,” “wider,” “narrower,” and similar terms, may be used herein to describe angular relationships. It is understood that these terms are intended to encompass different orientations of the elements or system in addition to the orientation depicted in the figures.

Although the terms first, second, third, etc., may be used herein to describe various elements, components, regions, and/or sections, these elements, components, regions, and/or sections should not be limited by these terms. These terms are only used to distinguish one element, component, region, or section from another. Thus, unless expressly stated otherwise, a first element, component, region, or section discussed below could be termed a second element, component, region, or section without departing from the teachings of the present disclosure. As used herein, the term “and/or” includes any and all combinations of one or more of the associated list items.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. For example, when the present specification refers to “an” assembly, it is understood that this language encompasses a single assembly or a plurality or array of assemblies. It is further understood that the terms “comprises,” “comprising,” “includes,” and/or “including” when used herein, specify the presence of stated features, integers, steps, operations, elements, and/or components, but do not preclude the presence or addition of one or more other features, integers, steps, operations, elements, components, and/or groups thereof.

Embodiments of the disclosure can be described herein with reference to view illustrations that are schematic illustrations. As such, the actual thickness of elements can be different, and variations from the shapes of the illustrations as a result, for example, of manufacturing techniques and/or tolerances are expected. Thus, the elements illustrated in the figures are schematic in nature and their shapes are not intended to illustrate the precise shape of a region and are not intended to limit the scope of the disclosure.

It is understood that while the present disclosure makes reference to speaker drivers with novel and efficient designs, and that speaker drivers may be the primary application concerned with the present disclosure, devices incorporating features of the present disclosure can be utilized with any application that has components or elements which might be concerned with audio devices and/or transducer applications, such as speakers, motors, actuators, sensors, or any similar application that may benefit from a novel and efficient component design.

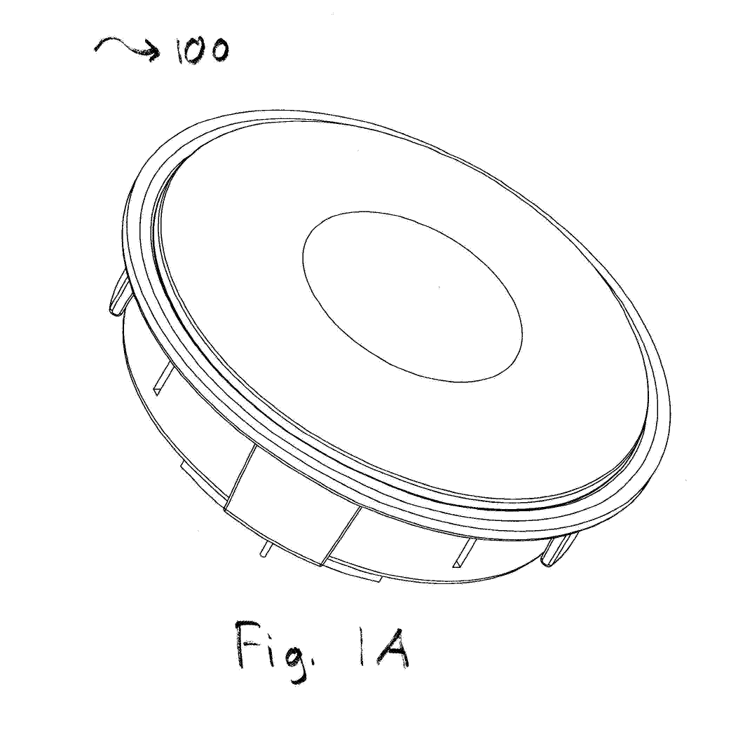

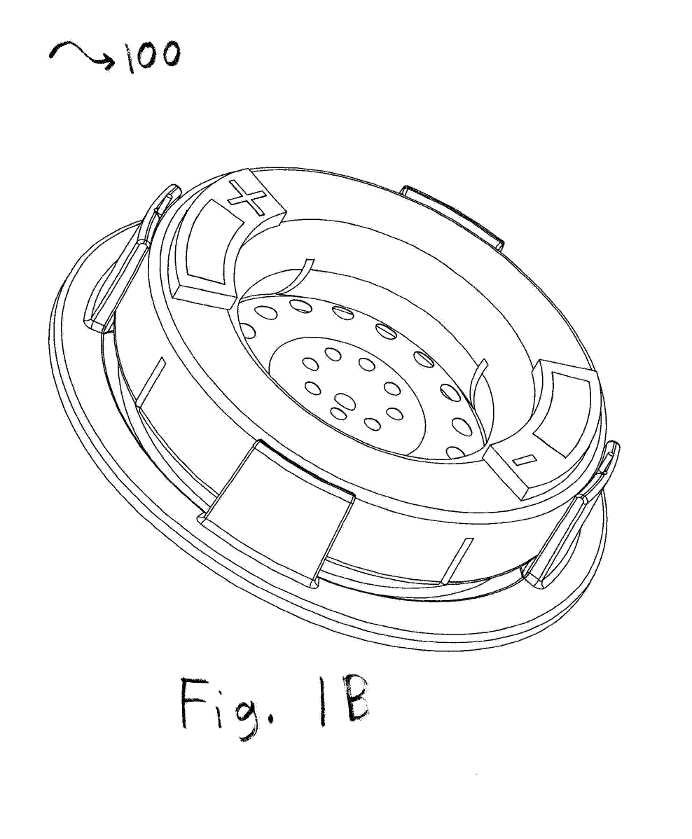

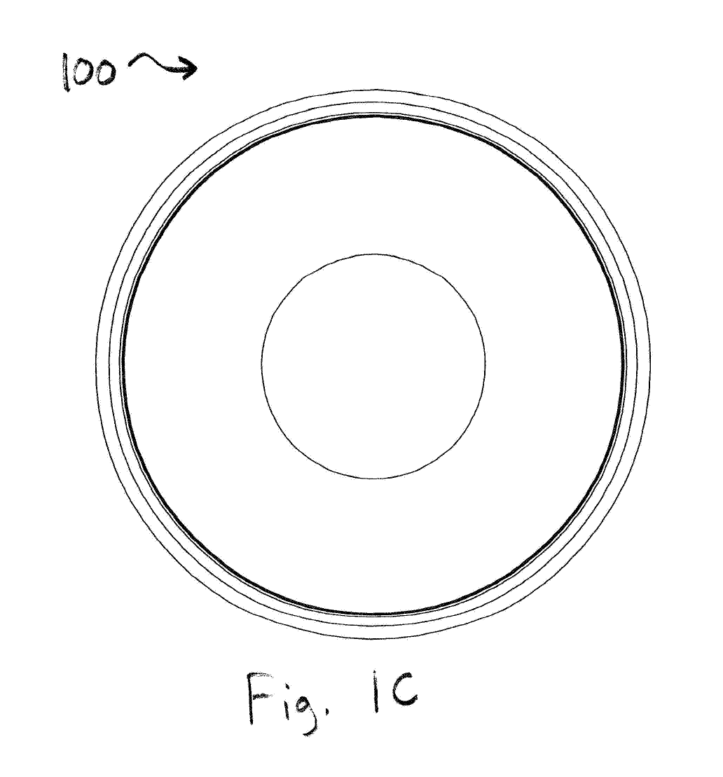

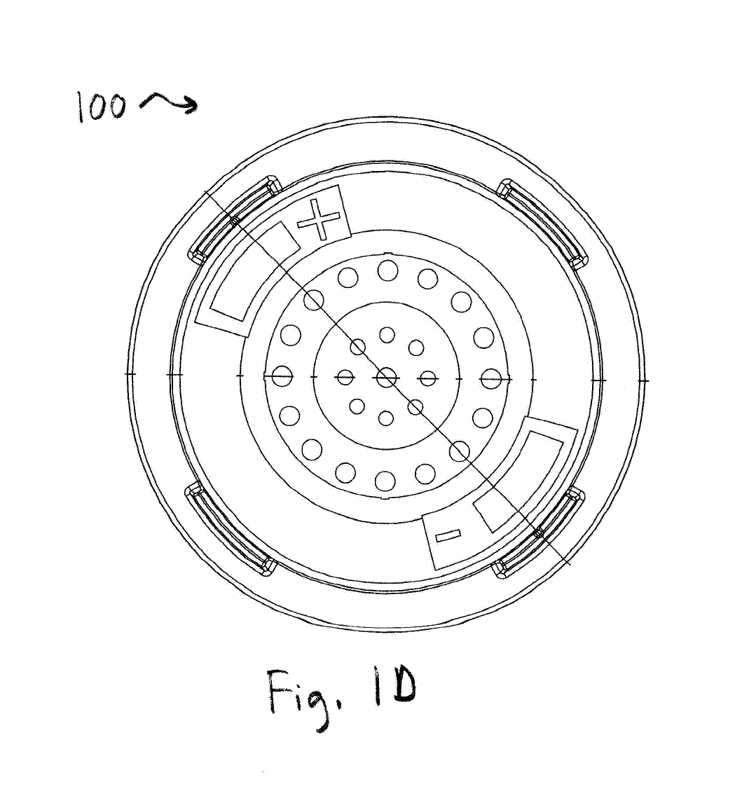

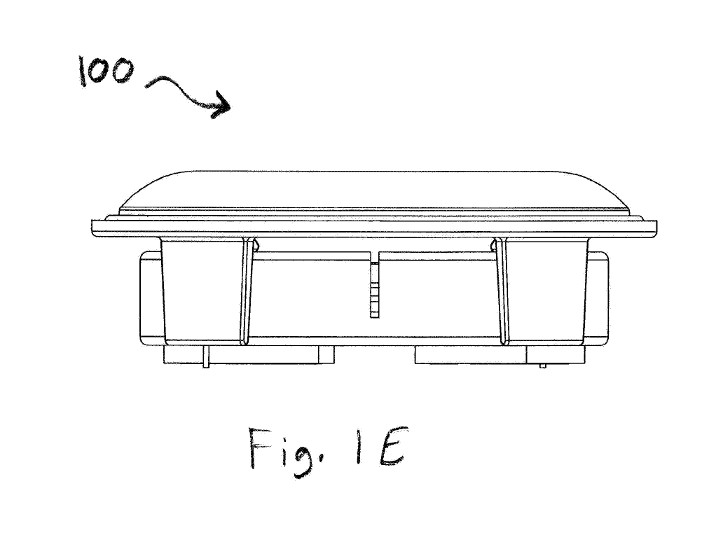

Embodiments according to the present disclosure can comprise speaker drivers with novel and improved structural integrity. FIG. 1A displays one embodiment of speaker driver 100, which comprises many of the novel and improved features described herein. For instance, speaker driver 100 can have features that optimize structural integrity. Speaker driver 100 can also include novel inverted dome designs which improve the structural integrity of the speaker driver, such as by facilitating the construction of strategic structural reinforcement devices. One manner in which speaker driver 100 can achieve these advantageous features is by bending back the dome edge to form a type of trough to build a reinforcement ring without introducing any unnecessary mass. By including these types of features, speaker driver 100 can simplify the manufacturing process, lower the manufacturing cost, and/or reduce the overall weight of the device. It is understood that speaker driver 100 can be referred to as a speaker driver, driver, and/or audio transducer, as well as any other appropriate term.

In order to show speaker driver 100 in its entirety, FIGS. 1B-1E provide several differently angled views of speaker driver 100.

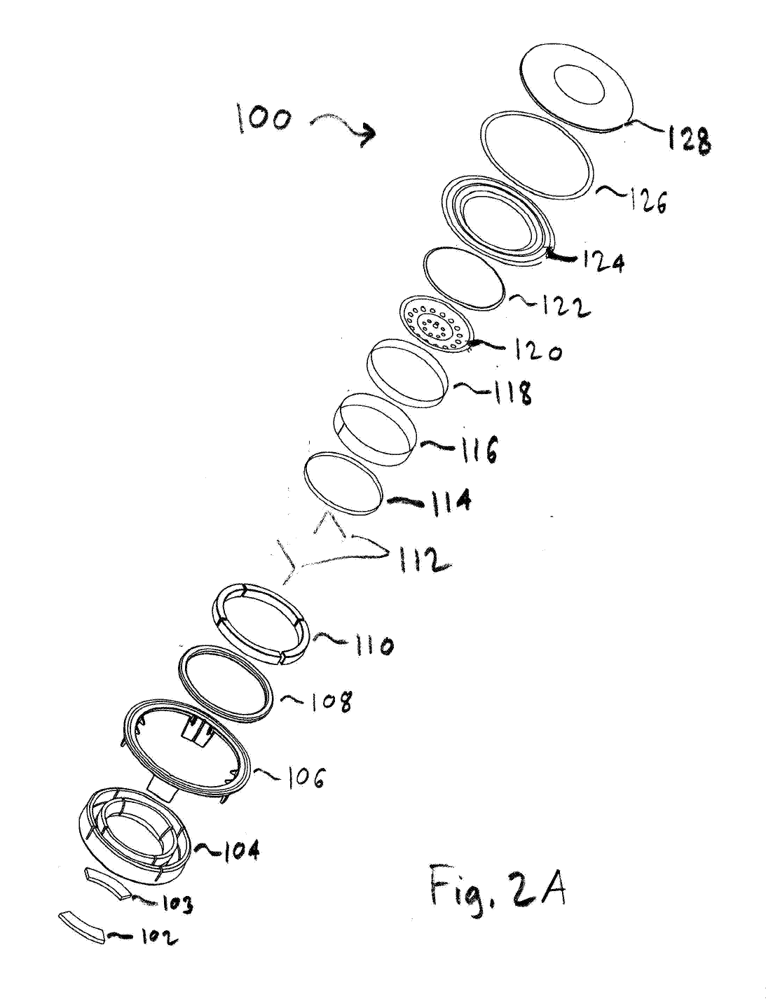

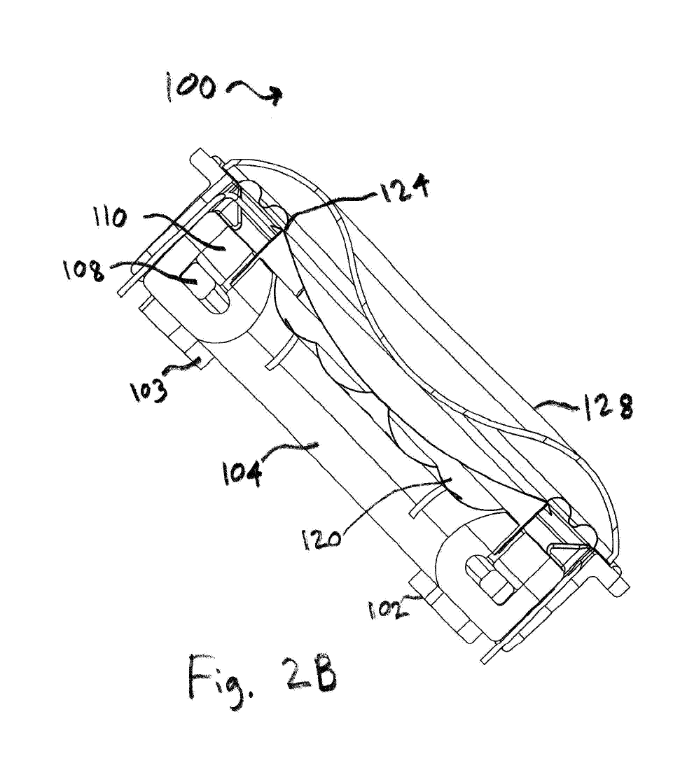

The speaker drivers according to the present disclosure comprise many different components. FIG. 2A displays that speaker driver 100 comprises inverted dome 122, front suspension 124, voice coil 114, and bobbin 116. Along with the reinforcement ring, these components make up the reinforcement assembly portion of the driver. Speaker driver 100 also comprises base cup 104, Faraday ring 108, and magnet 110, which make up the motor assembly portion of the driver. Other speaker driver components that are adjacent the motor assembly are basket 106 and terminal board 102/103. Moreover, speaker driver 100 comprises tensile wire 112, collar 118, rear suspension 120, suspension ring 126, and grille 128.

The relative position of each component is important to the ability of the speaker driver to function property. Accordingly, FIG. 2B provides a view of the respective component positions of speaker driver 100.

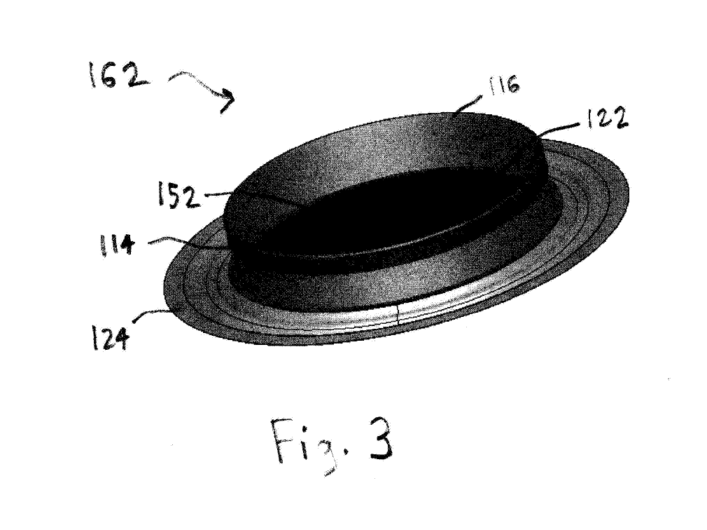

Some of the novel and improved features of the present disclosure relate to structural integrity of the speaker driver. FIG. 3 displays reinforcement assembly 162, which comprises inverted dome 122, front suspension 124, voice coil 114, bobbin 116, and reinforcement ring 152. As described herein, the components of reinforcement assembly 162 can improve the structural integrity of speaker driver 100 by increasing the radial tensile strength. In turn, this raises the dome break up frequency of the device and improves the overall failure rate of the driver.

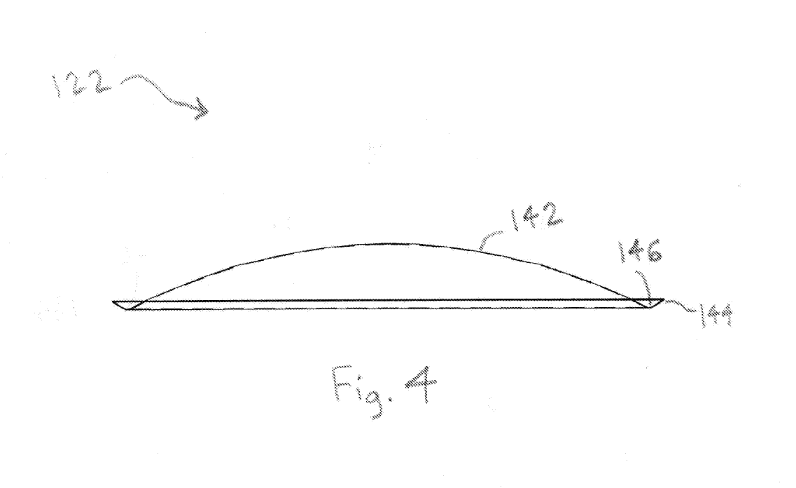

Embodiments of the present disclosure can also include novel and improved dome structures. FIG. 4 displays inverted dome 122. Inverted dome 122 comprises dome center structure 142, dome edge 144, and trough 146. As shown in FIG. 4, dome edge 144 is bent back at an angle adjacent to trough 146. More specifically, trough 146 is formed by dome edge 144 being bent back at the intersection with dome center structure 142. FIG. 4 displays one embodiment of the configuration of dome edge 144 being bent; however, it is understood that many different types of dome edges can be used.

The reverse bend of dome edge 144 and formation of trough 146 is significant for several reasons. For example, the strategic and novel shape of dome edge 144 allows trough 146 to form a shape which can mold an adhesive or glue into a reinforcement ring. In some embodiments according to the present disclosure, the adhesive or glue can be used to adhere voice coil 114 to the dome 122. As described herein, this molded adhesive or glue can become a type of reinforcement ring for the device.

The configuration of dome edge 144 and trough 146 provides many advantageous benefits to the speaker driver. In embodiments of the present disclosure, the dome edge 144 and trough 146 arrangement can correctly align other components, such as voice coil 114, bobbin 116, and/or front suspension 124. For instance, when the voice coil 114, bobbin 116, or front suspension 124 are adhered or glued to the dome 122, dome edge 144 and trough 146 can help to center the components such that they are properly aligned with the dome 122. Moreover, trough 146 can increase and/or improve the bonding area of dome 122, such that it is easier to bond voice coil 114, bobbin 116, front suspension 124, and/or other components to the dome 122 with adhesives or glues. Accordingly, dome edge 144 and trough 146 can improve the positioning and strength of bonding the voice coil 114, bobbin 116, and/or front suspension 124 to the dome 122.

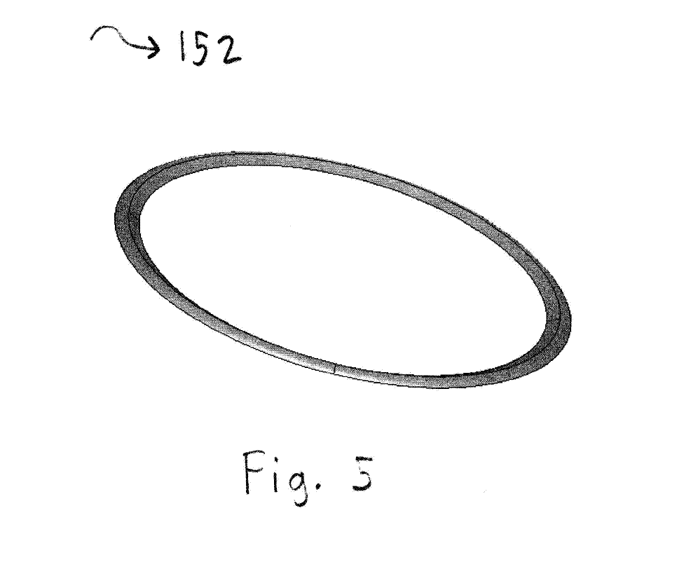

In addition, the configuration of dome edge 144 and trough 146 can increase the radial tensile strength of the device. Specifically, dome edge 144 and trough 146 allow the diameter and/or perimeter to be more structurally secure. As described herein and shown in FIG. 5, reinforcement ring 152 can be responsible for the increased diameter and/or perimeter structural stability, and corresponding increase in radial tensile strength. This increase in radial tensile strength provides a corresponding increase in the break up frequency or mode, which is also known as the high frequency limit of the speaker driver.

In most instances, a dome fails or breaks up because it structurally cannot handle high frequencies. Accordingly, once a speaker driver reaches a certain high level of frequency, the dome can structurally break down, which in turn causes the speaker driver to fail. The reason this occurs is as speaker driver frequencies increase, the center of the dome is more likely to expand and/or contract axially, which in turn causes the diameter of the dome to expand and/or contract radially. The lower the radial tensile yield strength of the dome, the more likely the diameter is to expand and/or contract in a radial direction.

One way to improve the radial tensile yield strength of the dome diameter, and reduce the amount of radial expansion and/or contraction, is to reinforce the perimeter of the dome. For example, if the perimeter of the dome is reinforced, such as with a reinforcement ring around the outside diameter, the dome diameter radial expansion/contraction can likewise be constrained. In turn, the dome center can become much more difficult to collapse axially, as the dome diameter radial expansion/contraction is constrained by the reinforcement ring. Accordingly, reinforcing the perimeter of the dome can cause the dome to reduce movement in both the axial and radial directions.

This increased axial/radial structural stability increases the structural resonance frequency, and likewise raises the frequency at which the dome fails or breaks up. Therefore, reinforcing the strength of the dome perimeter can decrease the likelihood of dome failure, i.e. raise the dome break up frequency. In the present disclosure, the radial tensile yield strength is increased by using the dome edge 144 and trough 146 to form reinforcement ring 152. In embodiments of the present disclosure, the dome break up frequency can be as high as 40 kHz. However, it is understood that embodiments according to the present disclosure can have a variety of dome break up frequencies.

Embodiments according to the present disclosure can have dome edges with a variety of bend angles. FIG. 4 displays that dome edge 144 is bent back at a 45° angle, but embodiments according to the present disclosure can utilize other degrees of bend back as well. For instance, embodiments according to the present disclosure can also comprise dome edge bend angles of 30° and 60°. In embodiments according to the present disclosure, the bend back angle of the dome edge is preferably between 20° and 70°. In embodiments with a more optimum bend back, the dome edge can be between 35° and 55°. However, it is understood that any appropriate degree of dome edge bend angle can be used. Accordingly, the dome edge can be bent back at an angle anywhere between 0° and 90°.

The bend back angle of the dome edge 144 can form a wide variety of different shapes. In some embodiments, the bend back angle can form a cone shape, which helps add to the geometrical stability and/or stiffness. In other embodiments, the bend back angle can be straight conical, curved, a combination of curved and linear, and/or parabolic. Each of these different bend back shapes can produce the same or different results, depending on the width of the bend back portion.

Embodiments of the present disclosure can also comprise novel dome structure shapes. In some embodiments, dome center structure 142 can comprise a catenary shape. Catenaries are the strongest type of dome structure or geometry, which are similar to parabolas. For example, catenaries are used in objects that require a very strong structure, such as bullet tips, rocket noses, airplane noses, bridge arches, and door arches. A catenary dome can have a smaller tip radius than a spherical dome, so that it can resist collapse and spread the stress over the entire surface of the dome. Accordingly, the catenary shape of dome center structure 142 can contribute to raising the break up frequency of the device. Dome center structure 142 can also comprise a number of other appropriate shapes, including but not limited to spherical, parabolic and/or conical. It is understood that dome structures in embodiments according to the present disclosure can be any appropriate shape.

In embodiments according to the present disclosure, dome 122 can be connected to other components, such as the voice coil 114, bobbin 116, and/or front suspension 124. In embodiments according to the present disclosure, the diameters of dome 122 and voice coil 114 or bobbin 116 can be similar, such that there can be a limited excess dome diameter outside of the connection point of these components. This can be due to several different factors, such as the dome bend back discussed above. In other embodiments, there can be an excess diameter outside of the connection point of the above components. It is understood that dome 122 can be referred to as a diaphragm or a cone, as well as any other appropriate term.

Domes according to the present disclosure can comprise a number of different materials. For instance, dome 122 can comprise beryllium, AlBeMet, aluminum, and/or aluminum alloy. Dome 122 can also comprise magnesium, titanium, diamond, carbon fiber, paper, hard plastics, plastic films, metals, metal foils, metal alloys, ceramics and/or other materials with strong structural fibers. In some embodiments according to the present disclosure, dome 122 can comprise rubber, silk, polyester fabric, Kevlar, and/or Mylar. It is understood that domes of the present disclosure can comprise any number of appropriate materials.

Dome 122 can also comprise a variety of different dimensions. In one embodiment, dome 122 has a diameter of 34 mm and is 0.05 mm thick. In some embodiments, dome edge 144 has a bend back between 0.5 mm and 1 mm. However, the bend back length depends on the type of material of dome 122. A thicker membrane material, e.g. paper, plastic foam, or sandwich construction requires a wider bend back. It is understood that dome 122 can comprise any number of appropriate dimensions.

Embodiments according to the present disclosure can also include components to improve the radial yield strength. FIG. 5 displays one embodiment of a reinforcement ring 152 according to the present disclosure. As mentioned herein, reinforcement ring 152 can be formed by the dome edge 144 and trough 146, and can increase the radial yield strength of dome 122. To form reinforcement ring 152, dome edge 144 is bent back and forms trough 146 at the intersection with dome center structure 142. Specifically, trough 146 holds adhesive and/or glue that is used to adhere other components to dome 122, such as voice coil 114, bobbin 116, and/or front suspension 124. This hardened adhesive and/or glue forms reinforcement ring 152.

As reinforcement ring 152 can be formed with adhesive and/or glue that would otherwise be used to adhere other speaker driver components, the reinforcement ring is a novel and inventive aspect of speaker driver 100. Indeed, reinforcement ring 152 is a negligible mass addition to the speaker driver, as the adhesive and/or glue that forms reinforcement ring 152 would be used to adhere other speaker driver components even without the need for radial tensile reinforcement. Further, reinforcement ring 152 does not add any unnecessary manufacturing steps. Therefore, reinforcement ring 152 can simplify the overall manufacturing process, lower the manufacturing cost, and/or reduce the overall weight of the speaker driver.

As described herein, reinforcement ring 152 can increase the radial tensile strength of the speaker driver by constraining the expansion/contraction of the dome diameter. More specifically, reinforcement ring 152 is formed in trough 146 and dome edge 144, such that it restricts the radial movement of the dome 122. As reinforcement ring 152 constrains the dome radial movement, it can in turn restrict the axial movement of dome center structure 142. Accordingly, reinforcement ring 152 raises the dome break up frequency, and reduces the likelihood that dome 122 will fail.

Reinforcement ring 152 can comprise a variety of different materials, such as adhesives or glues. For example, in embodiments according to the present disclosure reinforcement ring 152 can comprise epoxy glues and/or cyanoacrylate, e.g. acrylic super glue. Further, as the reinforcement ring's primary applied load is radial tension and/or compression, materials with a high tensile yield strength can be used, such as hard plastics, metals, ceramics and/or materials with strong structural fibers. Thus, the adhesives or glues that form the reinforcement ring can also comprise high yield strength reinforcing fibers, particles and/or hollow balloons comprising glass, mineral, aramid, carbon and/or ceramic. While cyanoacrylate and epoxy glues can be hard with high tensile strength, this is especially true if they contain reinforcement fillers. Accordingly, reinforcement ring 152 can comprise adhesives or glues with reinforcement fillers. It is understood that reinforcement ring 152 can comprise any number of appropriate materials. Although the adhesives or glues may have a lower yield modulus than the dome 122 material, reinforcement ring 152 can be thicker than the dome 122, which adds the necessary radial tensile strength.

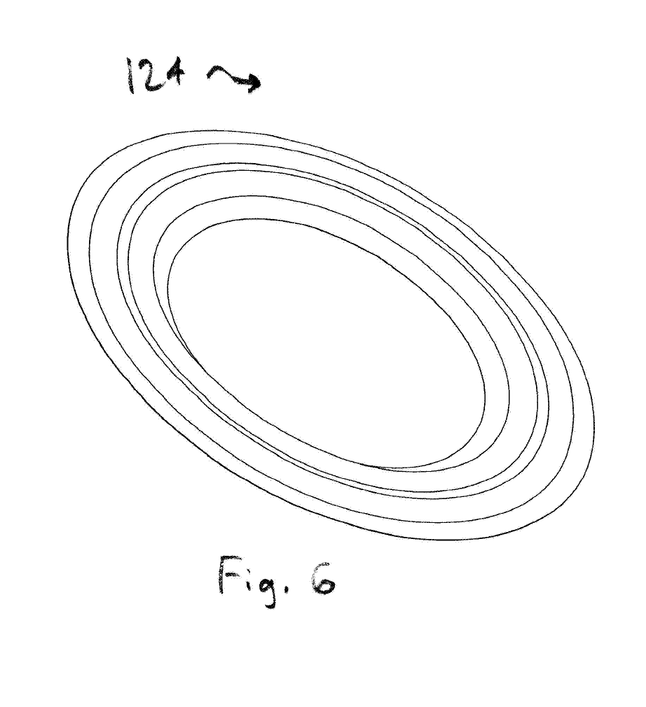

Embodiments of the present disclosure can also comprise several different components used for reinforcement and structural stability. FIG. 6 displays one embodiment of a front suspension 124 according to the present disclosure. In embodiments according to the present disclosure, front suspension 124 can be connected to the dome 122 with an adhesive or glue. For instance, reinforcement ring 152 can adhere front suspension 124 to dome 122. In some embodiments, the front suspension 124 can be connected to the surface of dome 122, wherein it contributes to the dome's structural stability. In other embodiments, front suspension and dome can be molded from the same component, such that they comprise a single piece structure.

FIG. 6 shows that front suspension 124 can comprise a polyester fabric that is PVA coated. Front suspension 124 can also comprise a suspension width of 5.5 mm. Additionally, the front suspension can comprise a tweeter dome fabric thickness or coating. It is understood that front suspension 124 can comprise any number of appropriate materials. The front suspension design can also be relatively soft over the necessary +/−Xmax excursion, such that it does not cause the dome to flex. Additionally, the front suspension 124 can be adhered or glued to the curved surface of dome 122, so that it does not cause the dome 122 to unnecessarily flex.

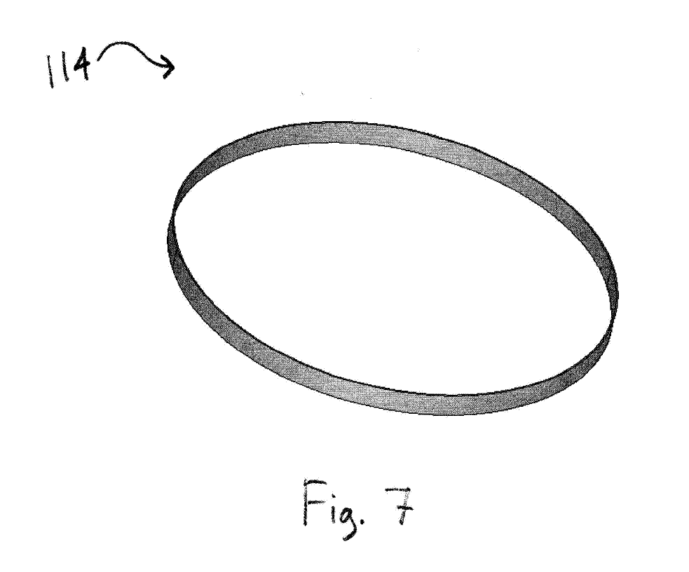

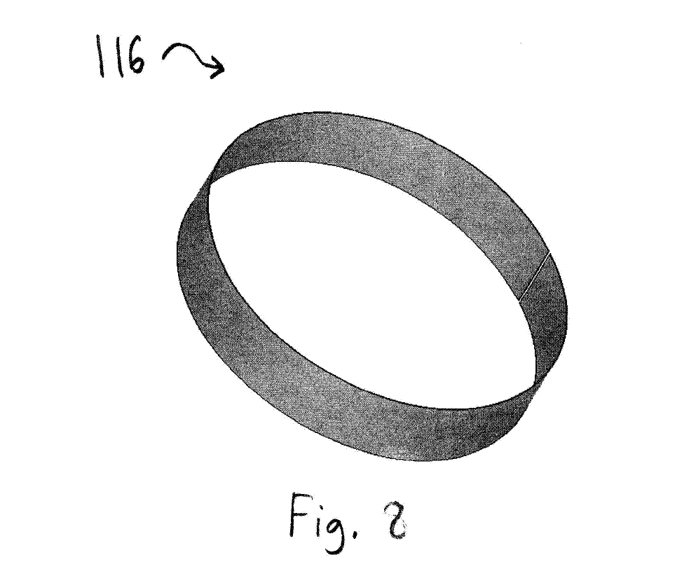

Embodiments of the present disclosure can also comprise novel and improved voice coils and bobbins. FIG. 7 displays voice coil 114, while FIG. 8 shows bobbin 116. Voice coils according to the present disclosure can be a wide variety of lengths, such as under hung, over hung, or equal hung, as well as any other appropriate length. In one embodiment, the voice coil can comprise a 32 mm diameter and a 1.75 mm thickness. The voice coil 114 can also comprise two layers, a CCAW of 0.06 mm×42.5 turns, a 1.75 mm wind width, and a DCR of 27 ohm. Bobbin 116 can comprise Kapton or other similar materials. However, it is understood that voice coils and bobbins according to the present disclosure can comprise any number of appropriate materials or dimensions.

Embodiments according to the present disclosure can also comprise other components that can be used in conjunction with voice coils and bobbins. For instance, collar 118 and tensile wire 112 (both shown in FIG. 2A) can comprise Nomex and Taiwan Maiden anti-roping, respectively. In some embodiments, tensile wire 112 can be 0.5 mm×35 mm long. It is understood that other components according to the present disclosure, such as collars and tensile wires, can comprise any appropriate material or dimension.

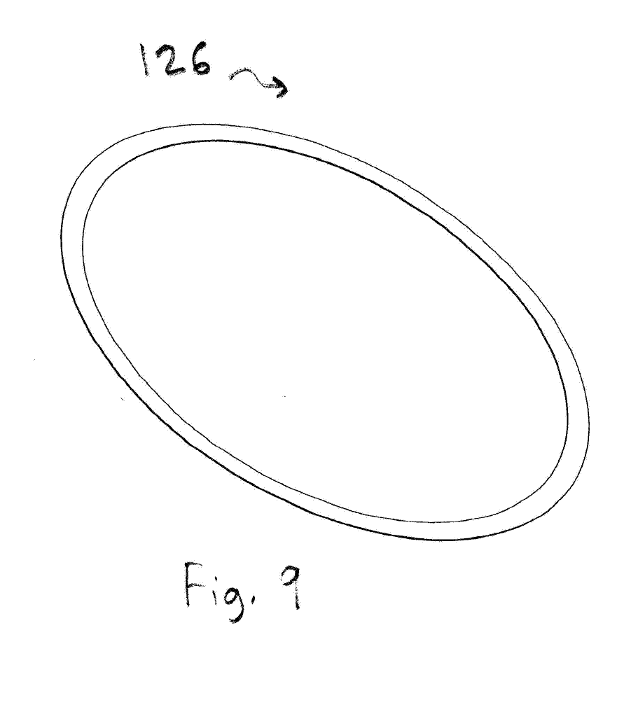

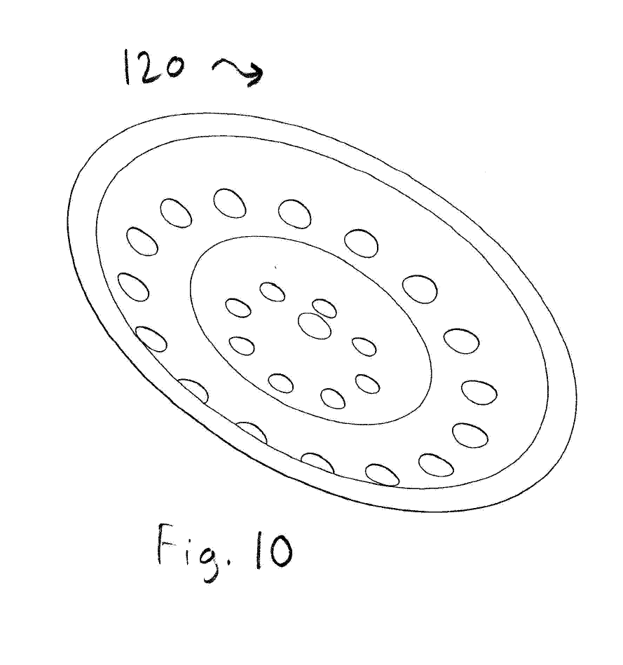

Embodiments of the present disclosure can also comprise several different components used for suspension, such as a suspension ring and a rear suspension. FIG. 9 displays suspension ring 126 that can comprise a plastic material, such as a clear Polyethylene naphthalate (PEN) plastic. Suspension ring 126 can also comprise any other material that can provide good reinforcement and flatness characteristics. FIG. 10 displays rear suspension 120. Like the front suspension, the rear suspension can also comprise a polyester fabric that is PVA coated, and comprise a tweeter dome fabric thickness and coating. In one embodiment, the rear suspension has a diameter of 31 mm and a thickness of 2.77 mm. However, it is understood that suspension components according to the present disclosure can comprise any number of appropriate dimensions or materials.

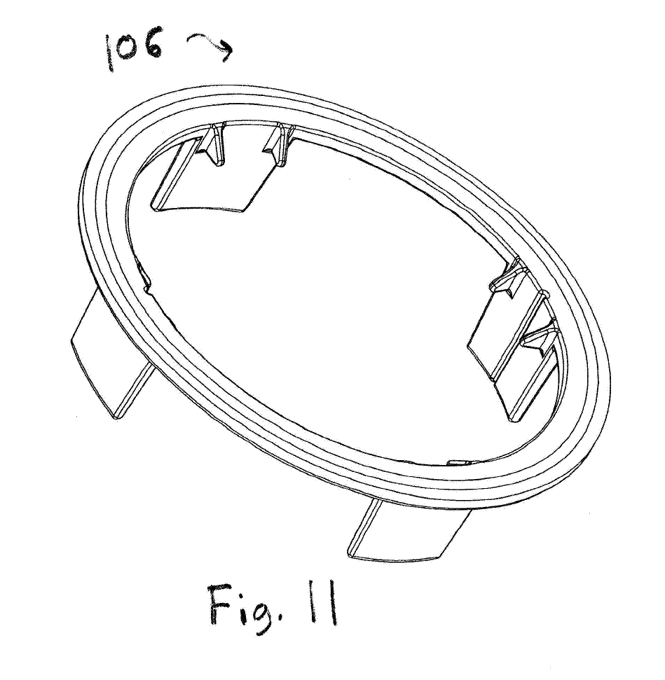

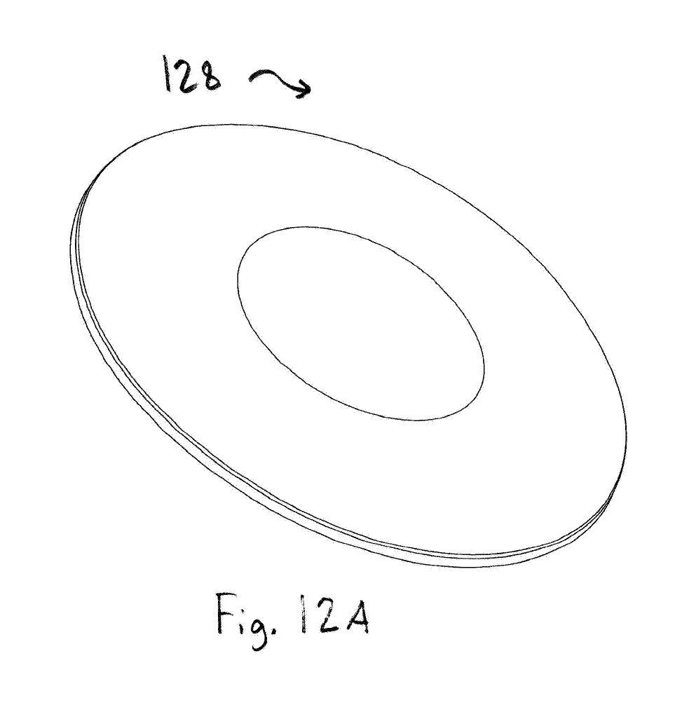

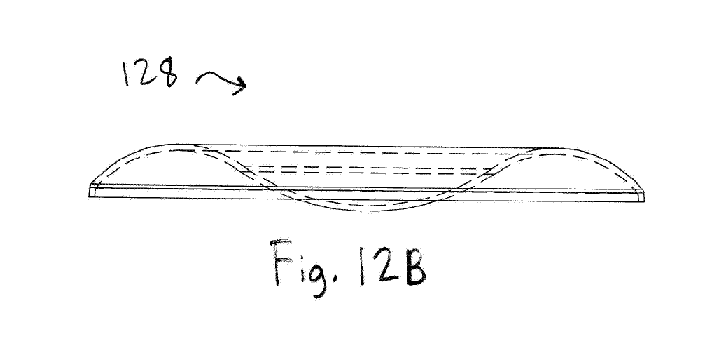

Speaker driver embodiments according to the present disclosure can comprise components such as baskets or grilles. FIG. 11 displays basket 106, which can comprise a plastic material, such as black ABS plastic. In one embodiment, basket 106 can have a mass of 1.67 grams and a diameter of 52 mm. FIGS. 12A and 12B displays grille 128, which can comprise a steel material, such as 316 stainless. The grille can also be hexagonally perforated with a 79% open area, including a 0.5 mm thickness. The grille can also comprise a black electroless nickel plate including 7% phosphorus. In one embodiment, grille can have a diameter of 47 mm and a mass of 1.7 grams. It is understood that baskets or grilles according to the present disclosure can comprise any number of appropriate dimensions or materials.

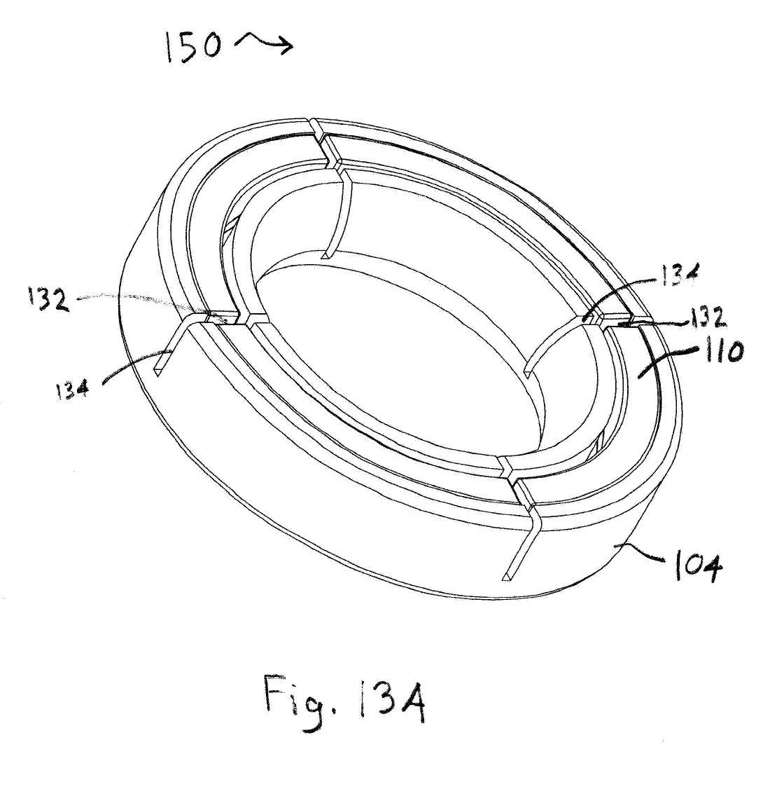

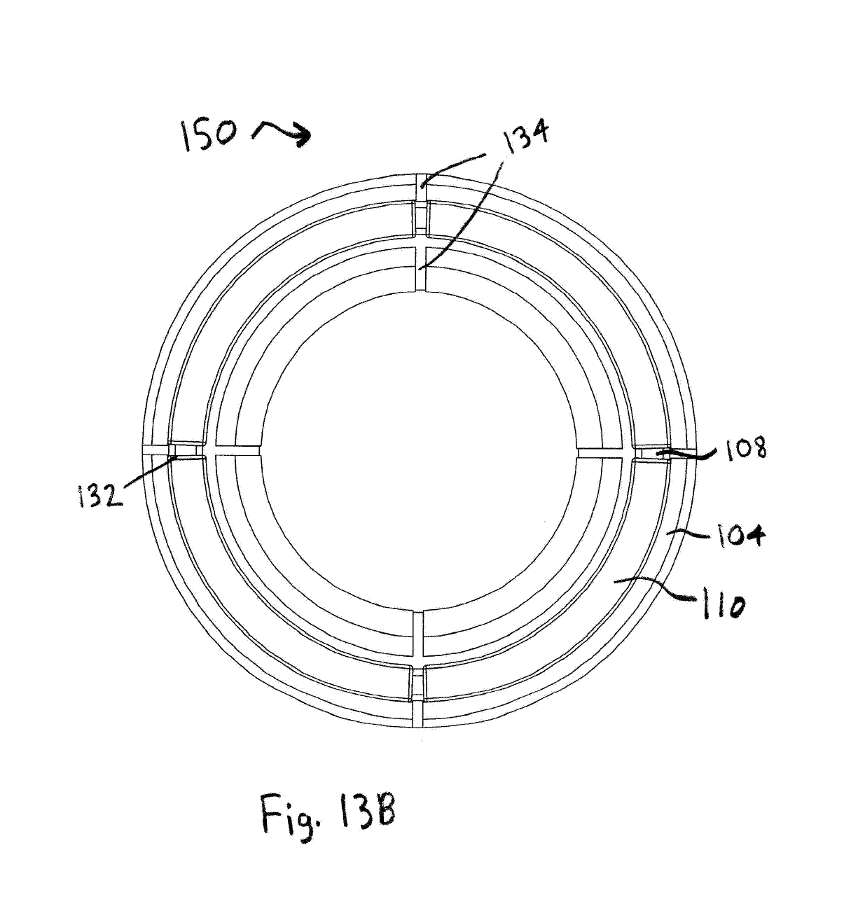

Embodiments of the present disclosure can also comprise speaker driver components that can help with alignment. FIGS. 13A and 13B display motor assembly 150. Motor assembly 150 comprises base cup 104, base cup slots 134, Faraday ring 108, magnet 110, and magnet gaps 132. As displayed in FIGS. 13A and 13B, base cup 104 and base cup slots 134 can be aligned with and magnet 110 and magnet gaps 132. Although FIGS. 13A and 13B display four magnet gaps 132 and four base cup slots 134, it is understood that any number of magnet gaps or base cup slots can be used, such as six, eight, or any other appropriate number.

Speaker driver designs herein can be scaled to any size speaker, such as hearing aids, in-ear monitors, other headphones, all types of microphones including dynamic microphones, micro speakers, tweeters, midrange speakers, woofers, and/or subwoofers. Motor assembly 150 can also comprise additional topologies, such as a multi-gap topology or any other appropriate topology. In one embodiment, the motor assembly can be 52 mm in diameter and weigh 51.5 grams. However, it is understood that motor assemblies according to the present disclosure can be any appropriate dimension or weight.

As shown in FIG. 13B, Faraday ring 108 can sit in the base cup 104 below magnet 110. In this manner, Faraday ring 108 can control the height of magnet 110 within the base cup 104. More specifically, Faraday ring 108 can control the height alignment of magnet gaps 132 with base cup slots 134. Accordingly, Faraday ring 108 plays an important role in the magnetic alignment within the speaker driver.

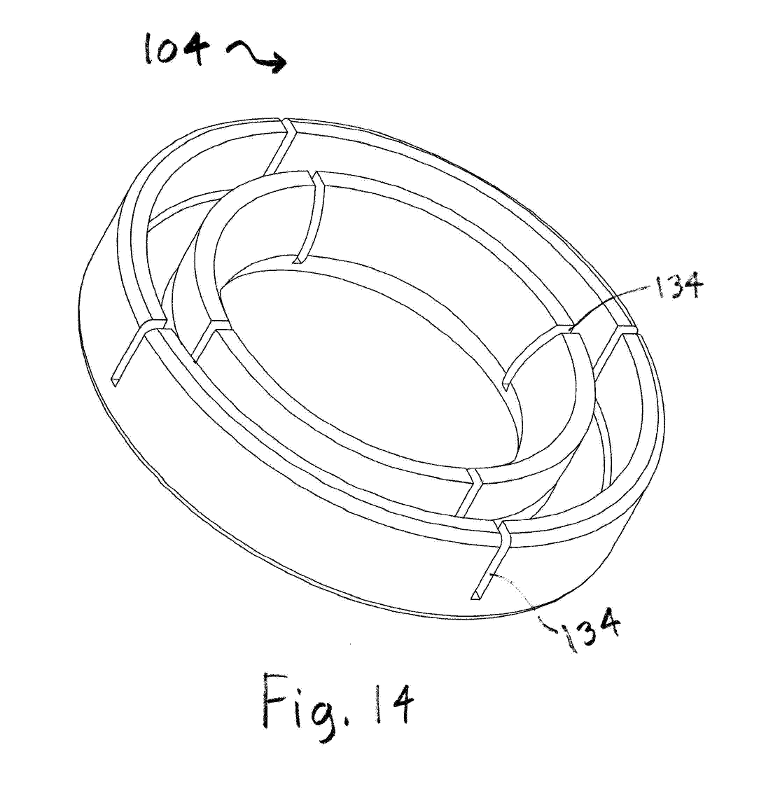

The individual components that make up motor assembly 150 are displayed in FIGS. 14-16. FIG. 14 displays base cup 104. As mentioned previously, base cup 104 comprises base cup slots 134 in both the inside and outside portions of the base cup. Base cup 104 can comprise a variety of different steel materials, including steel 1010 or steel 1008. Base cup can also comprise plating, such as Rohs compliant plating. This type of plating can be 5 microns thick, and comprise zinc and gold trivalent chromate. Additionally, base cup 104 can weigh approximately 40 grams. The length of base cup can be approximately 36 mm, with a tolerance of ±0.025 mm. Further, the flatness rate of base cup can be ±0.1 mm per 25 mm, and the surface finish can be 0.002 mm. However, it is understood that base cups according to the present disclosure can comprise any number of appropriate dimensions or materials.

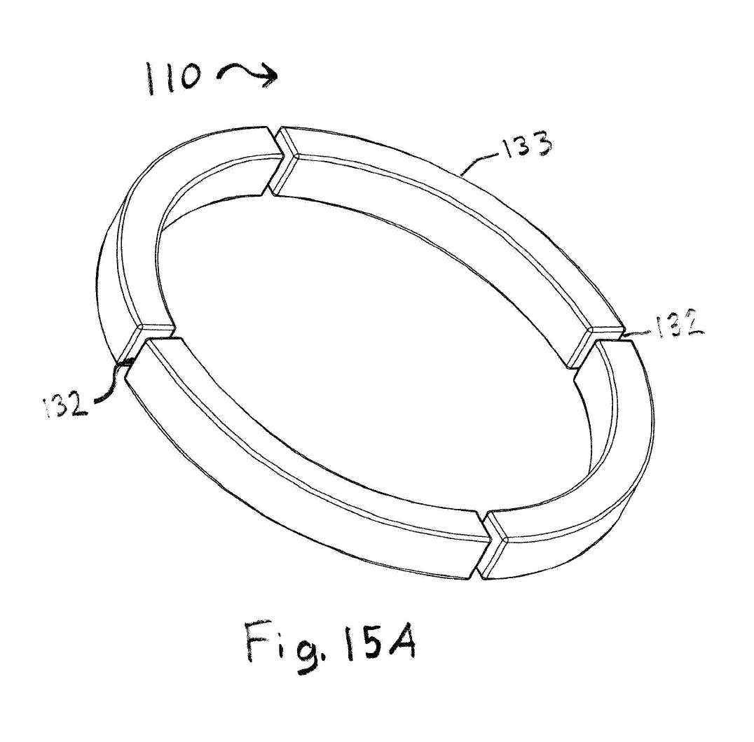

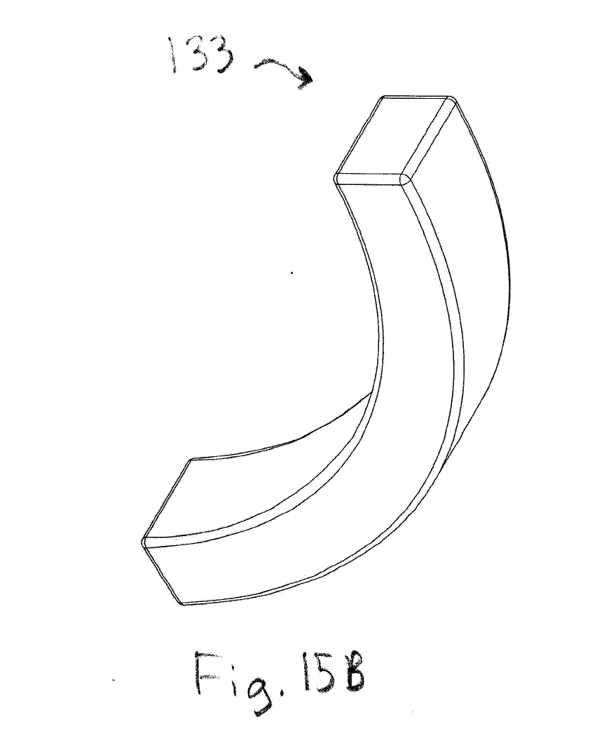

Embodiments according to the present disclosure can comprise several types of magnets. FIG. 15A displays magnet 110, which comprises one or more magnet gaps 132. In embodiments according to the present disclosure, magnet gaps 132 can run entirely through magnet 110. As shown in FIG. 15A, magnet 110 can actually comprise one or more segments 133. Although four individual segments are shown in FIG. 15A, it is understood that any appropriate number of magnet gaps and individual magnet segments can be used, such as four, five, six, seven, or eight segments.

As displayed in FIGS. 15A and 15B, magnet 110 can be a type of magnet suitable for speaker drivers, such as a radial magnet. Furthermore, magnet 110 can be in an arc shape, such that it can be referred to as an arc magnet. Magnet 110 can also be a combination of the aforementioned magnet types, wherein it can be a radial arc magnet. More specifically, magnet 110 can be a radial magnetized neodymium arc shape magnet. It is understood that magnets according to the present disclosure can be any other appropriate type of magnet. In some embodiments, magnet 110 comprises a ceramic material. However, any appropriate type of magnet material can be used, such as Ferrite, Neodymium, Samarium Cobalt, AlNiCo, electro magnet, or any other appropriate material. Magnets can also comprise a zinc plate and weigh approximately 2.4 grams. It is understood that magnets can weigh any appropriate amount and include any appropriate dimensions.

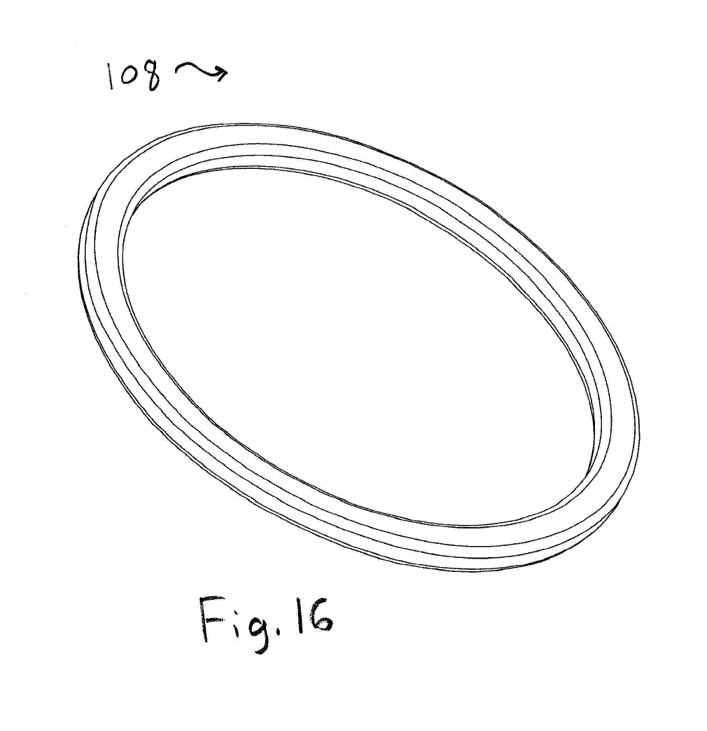

Other aspects of the speaker driver can reduce the buildup of inductance. FIG. 16 displays Faraday ring 108. Faraday ring 108 can have many benefits, such as reducing the buildup of, or linearizing, inductance, as well as increasing high frequencies or reducing intermodulation distortion. Essentially, Faraday ring 108 can cause current to correctly flow through the device. It is understood that Faraday ring 108 can also be referred to as a short-circuit ring or a shorting ring, as well as any other appropriate term.

As mentioned previously, Faraday ring 108 can reduce opposing “eddy” currents that would normally flow through the device. Faraday ring 108 accomplishes this by essentially short circuiting the eddy currents. Without the Faraday ring 108, the inductance in the device can increase significantly, which can likewise increase the temperature in the device. Faraday ring 108 can comprise a number of different materials with electrically conductive properties and/or low electrical resistance. For example, Faraday ring 108 can comprise aluminum, alloy aluminum, silver, copper, alloy copper, such as brass, bronze, other copper alloys or electrical grade alloys, as well as other appropriate non-ferrous or electrically conductive materials. In one embodiment, Faraday ring 108 can weigh a few grams, e.g. approximately 1.5 grams. However, it is understood that Faraday rings according to the present disclosure can weigh any other appropriate amount.

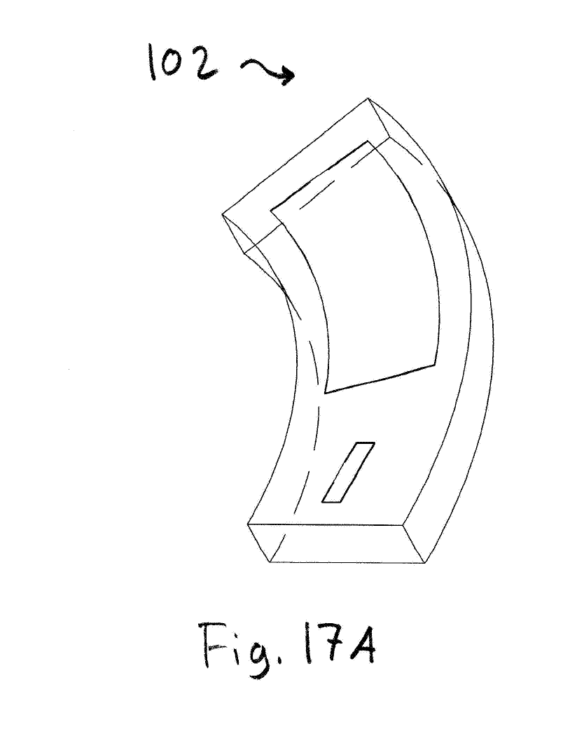

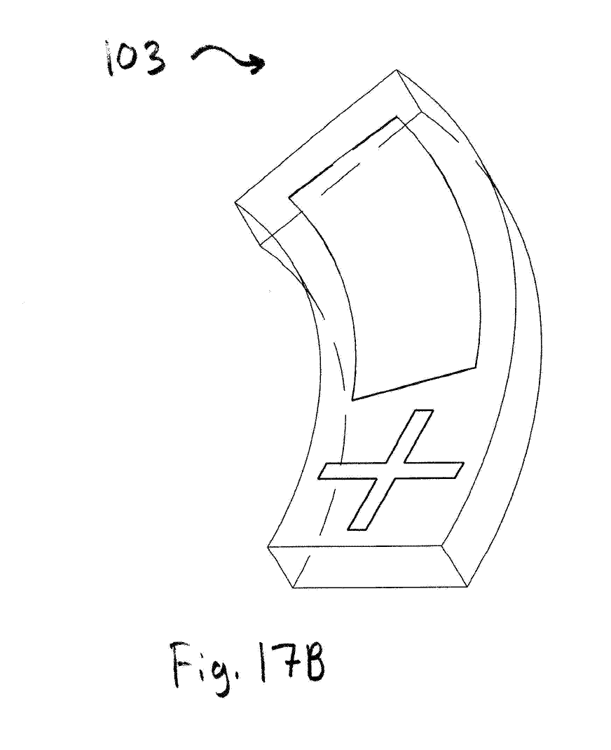

Embodiments according to the present disclosure can also comprise terminal boards, as displayed in FIGS. 17A and 17B. Specifically, FIG. 17A displays negative terminal board 102, while FIG. 17B shows positive terminal board 103. It is understood that some embodiments of the present disclosure may not use a terminal board, but rather an equivalent component, such a terminal strip or a printed circuit board, as well as any other appropriate component. In one embodiment, the terminal board comprises copper and tin material and is a black color. Specifically, the terminal board can comprise a tin plate and one ounce of copper. However, it is understood that terminal boards according to the present disclosure can comprise any appropriate material.

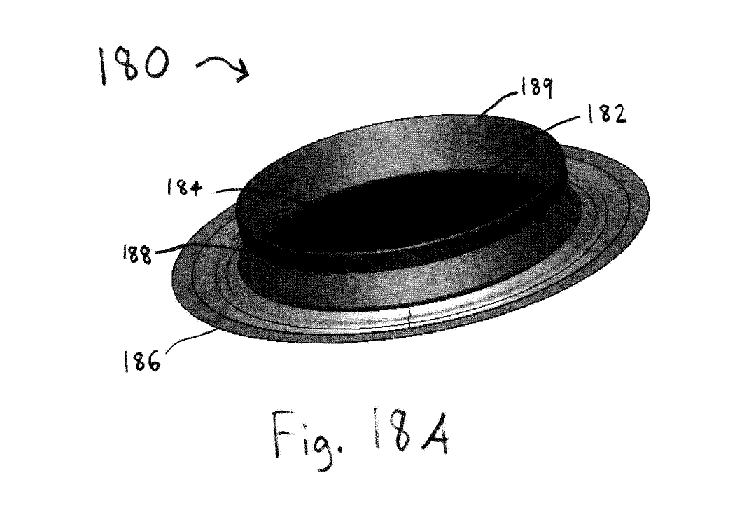

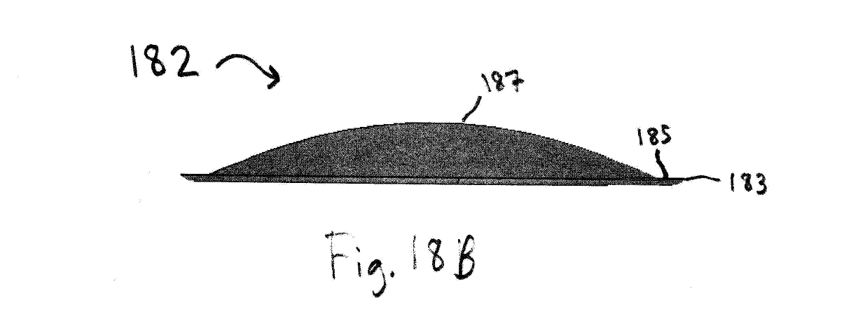

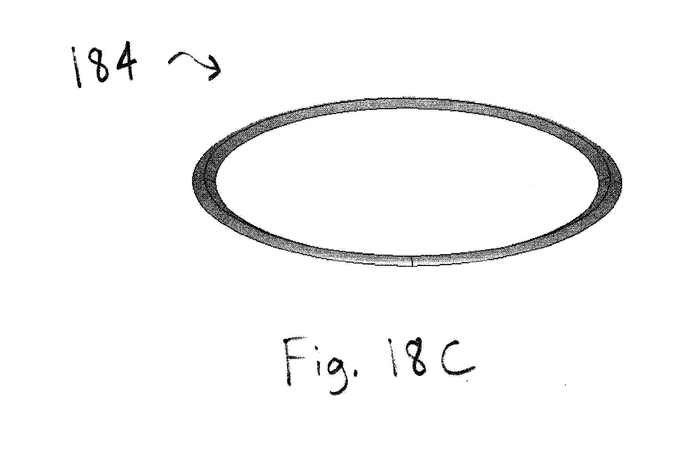

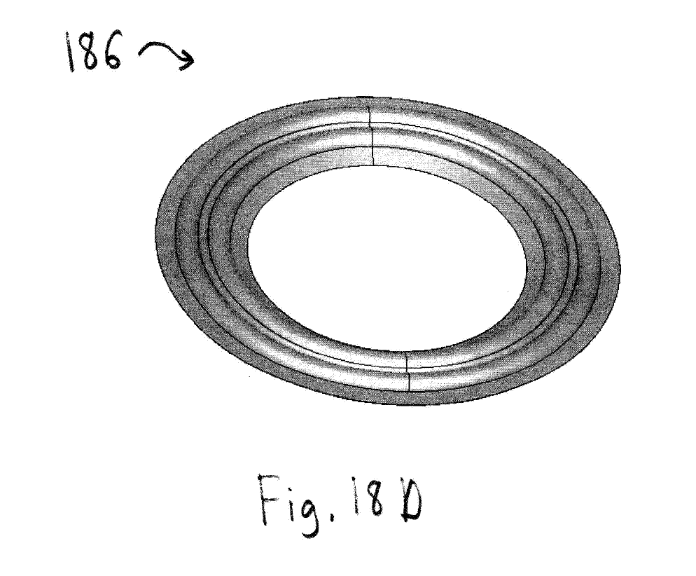

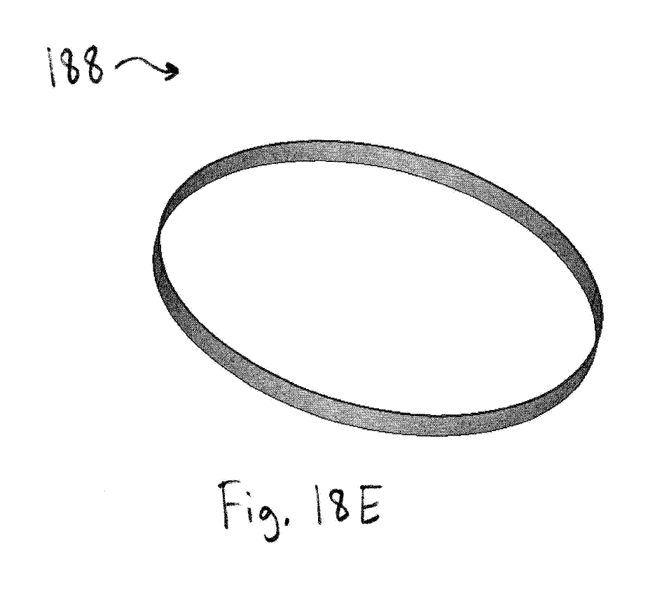

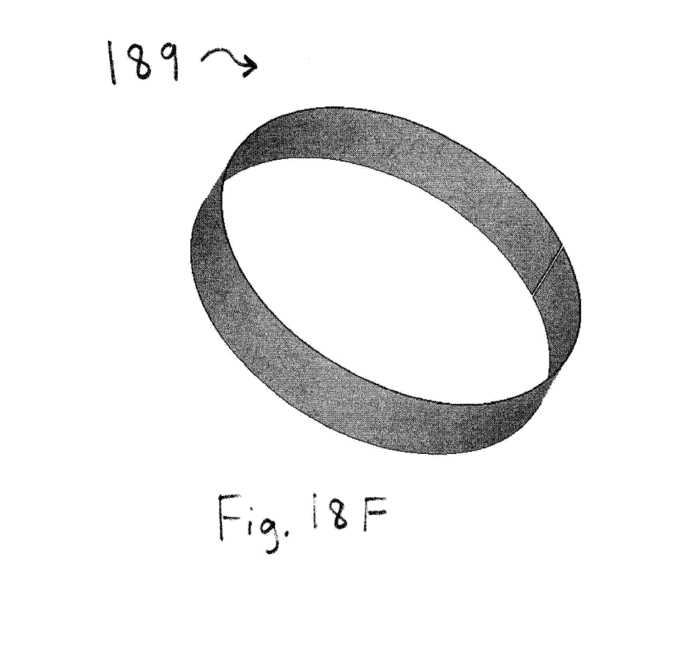

The present disclosure also provides embodiments with different speaker driver designs. For instance, reinforcement assemblies according to the present disclosure can have a wide variety of designs. FIGS. 18A-21E display several different embodiments of reinforcement assemblies. FIG. 18A displays one such type of reinforcement assembly 180. Reinforcement assembly 180 can comprise inverted dome 182, reinforcement ring 184, front suspension 186, voice coil 188, and bobbin 189. Each of these components are displayed in FIGS. 18B-18F, respectively.

Reinforcement assemblies can have components with varied structural angles. For example, inverted dome 182 includes a structure with a varied dome edge bend angle. As shown in FIG. 18B, dome edge 183 is bent back at an angle of 30°. In addition to dome edge 183, inverted dome 182 comprises trough 185 and dome center structure 187. Because dome edge 183 comprises a bend angle of 30°, trough 185 can comprise a corresponding structure. Accordingly, reinforcement ring 184 can also comprise a structure that corresponds to the 30° angle of dome edge 183, as it is molded in trough 185 between dome edge 183 and dome center structure 187.

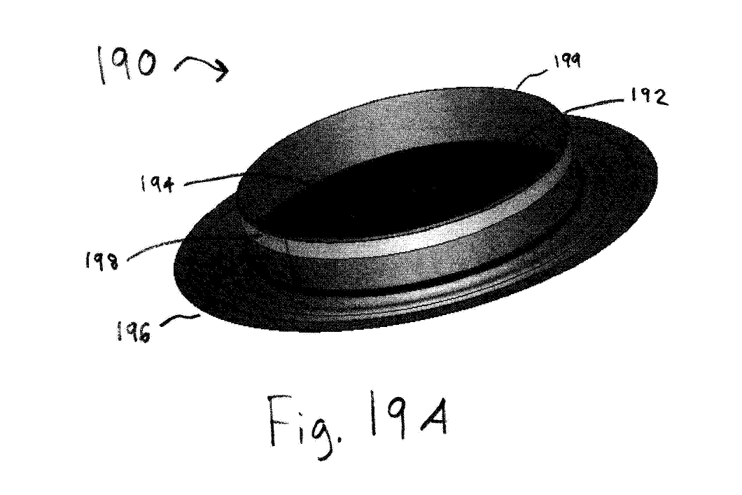

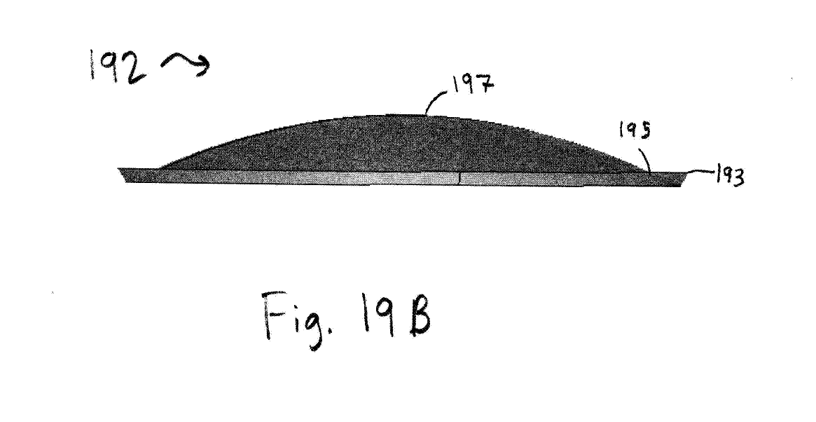

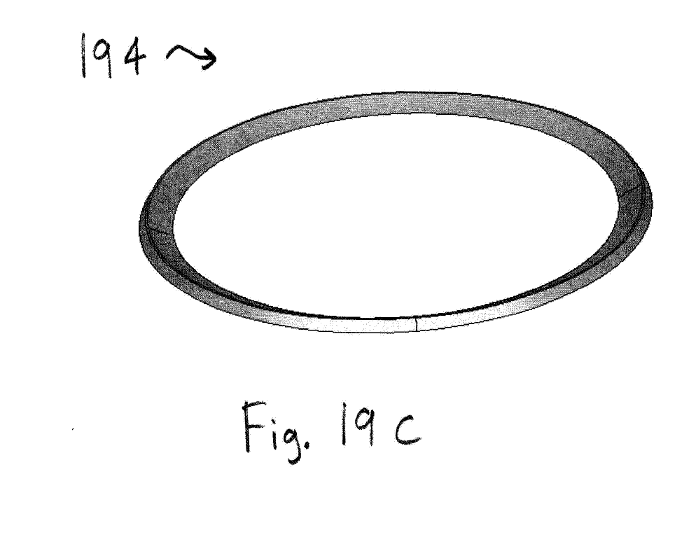

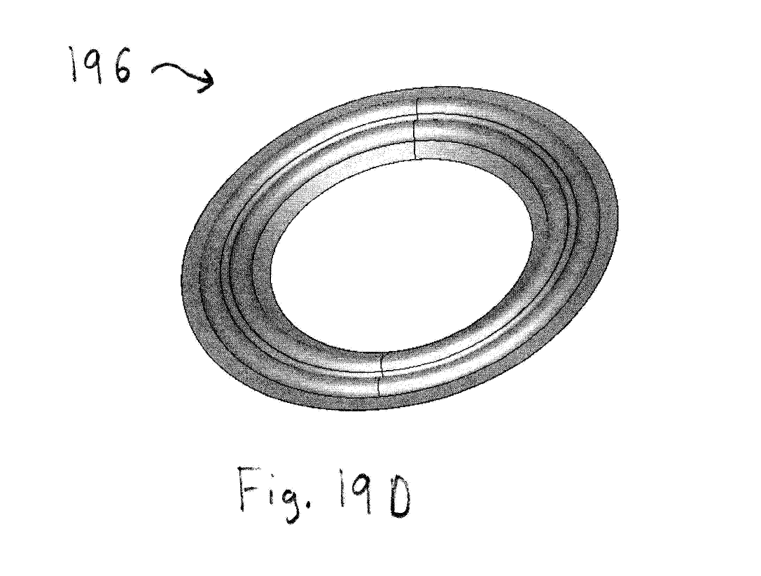

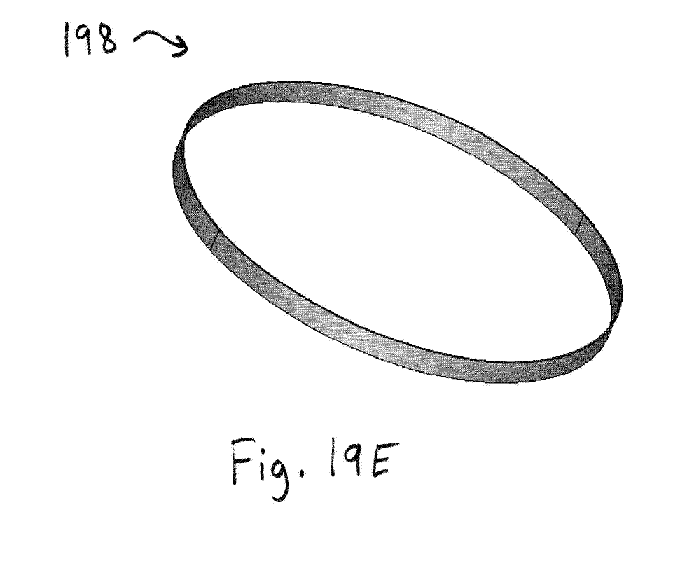

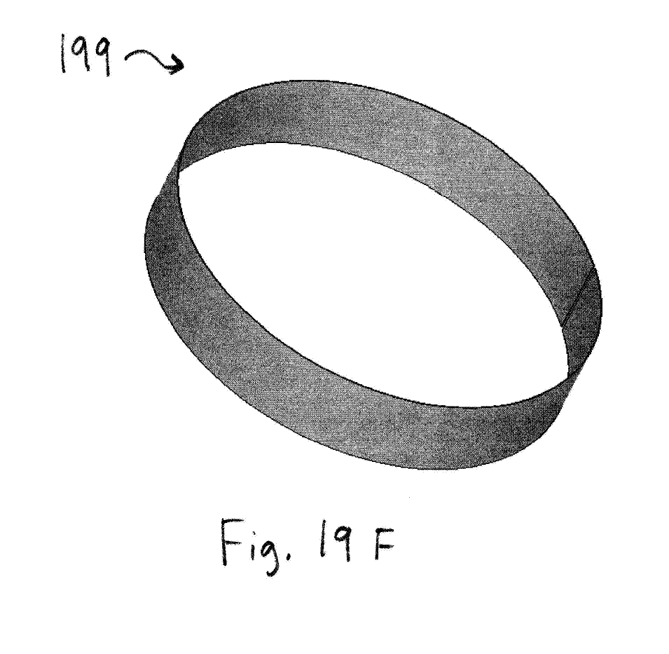

Components in reinforcement assemblies according to the present disclosure can comprise further variance in structural angles. FIG. 19A displays another such design of reinforcement assembly 190. Reinforcement assembly 190 can comprise inverted dome 192, reinforcement ring 194, front suspension 196, voice coil 198, and bobbin 199, each of which are displayed in FIGS. 19B-19F, respectively. As shown in FIG. 19B, inverted dome 192 comprises dome edge 193, which is bent back at an angle of 60°.

Inverted dome 192 also comprises trough 195 and dome center structure 197. As dome edge 193 comprises a bend angle of 60°, trough 195 can comprise a corresponding structure. Once again, reinforcement ring 194 can include a structure that corresponds to the 60° angle of dome edge 193, because it is molded in trough 195 between dome edge 193 and dome center structure 197. It is understood that embodiments according to the present disclosure can include a wide variety of appropriate dome edge bend angles, including any angle between 0° and 90°.

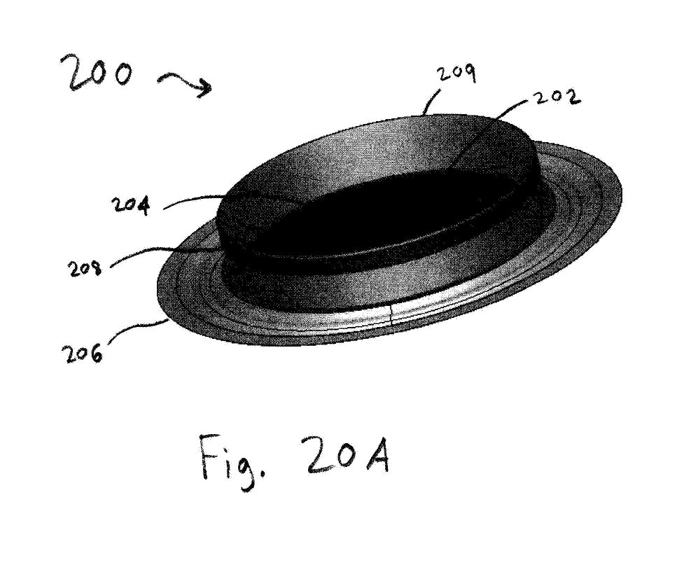

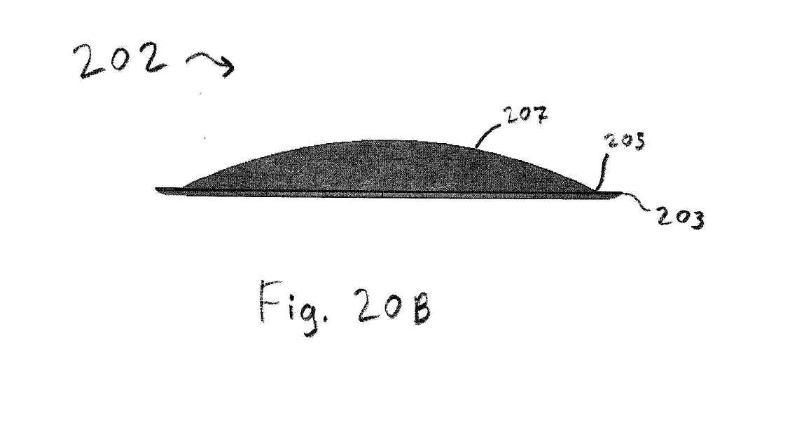

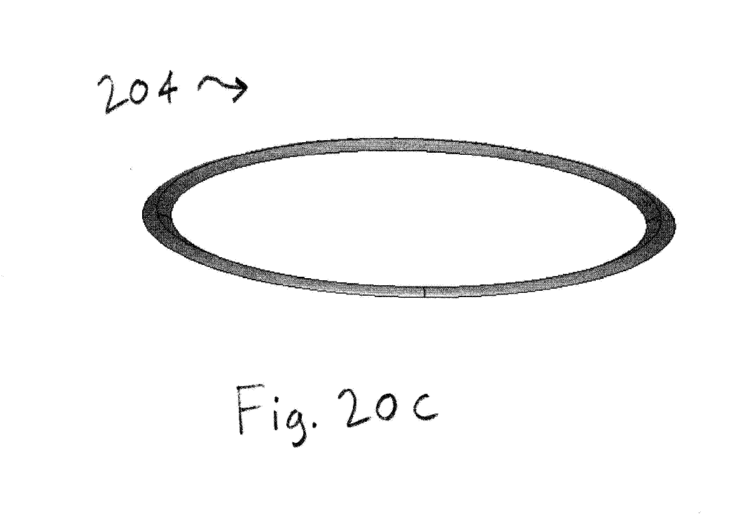

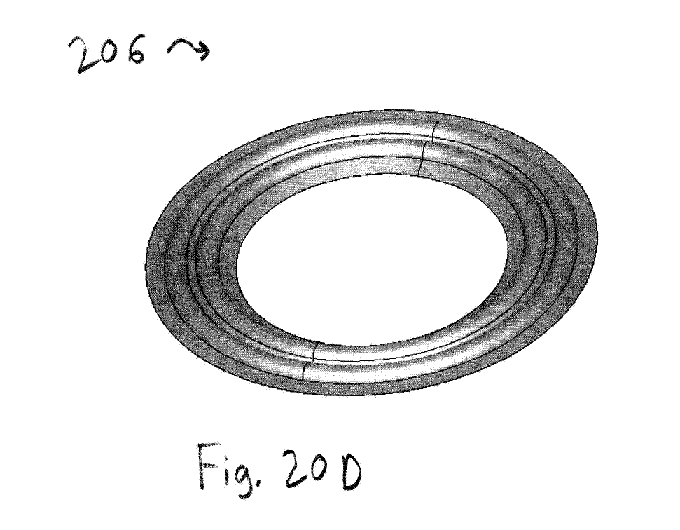

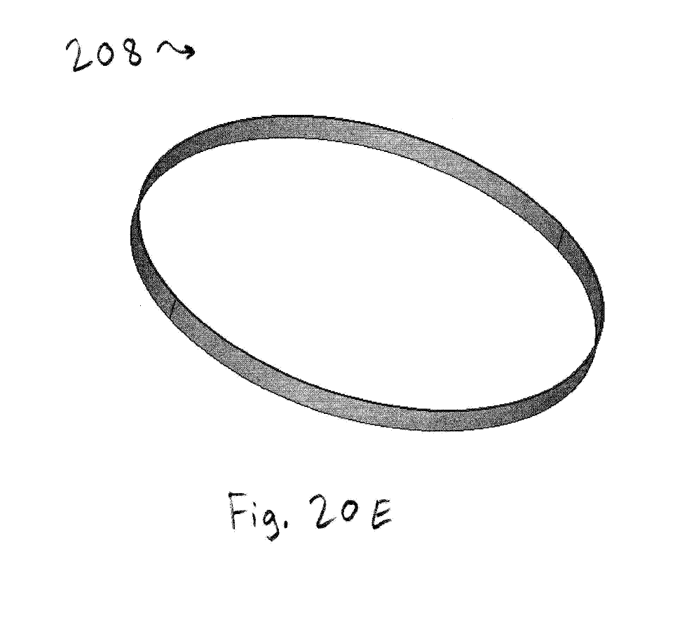

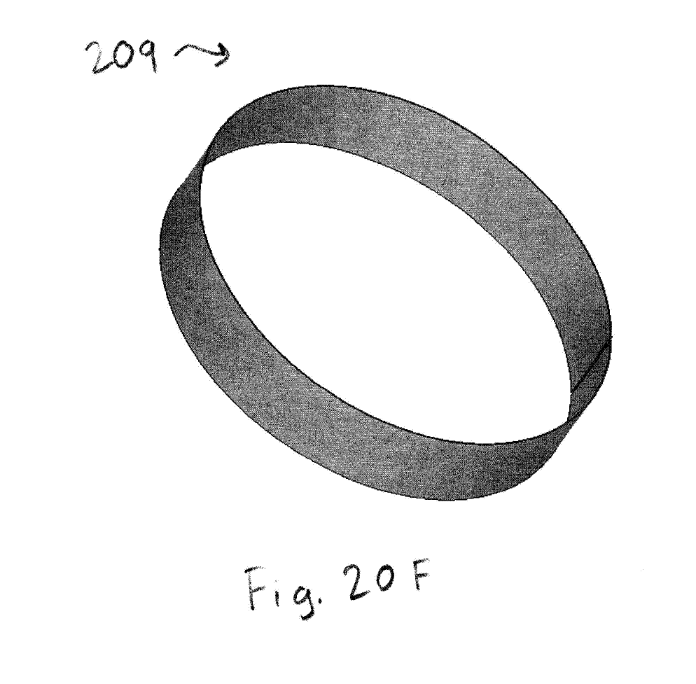

Embodiments according to the present disclosure can comprise components with a wide variety of different shapes. For example, reinforcement assemblies according to the present disclosure can comprise a wide variety of different dome shapes. FIG. 20A displays one such design of reinforcement assembly 200. Reinforcement assembly 200 comprises inverted dome 202, reinforcement ring 204, front suspension 206, voice coil 208, and bobbin 209. Each of these components are displayed in FIGS. 20B-20F, respectively.

Inverted dome 202 includes a structure with a varied shape of dome edge 203. Specifically, dome edge 203 comprises a curved shape, as shown in FIG. 20B. Inverted dome 202 comprises trough 205 and dome center structure 207. As dome edge 203 is curved, both trough 205 and reinforcement ring 204 can comprise corresponding structures. Other embodiments according to the present disclosure can comprise different dome edge shapes. For instance, dome edge shapes according to the present disclosure can be conical, curved, a combination of curved and linear, and/or parabolic. It is understood that embodiments according to the present disclosure can include any appropriate dome edge shape.

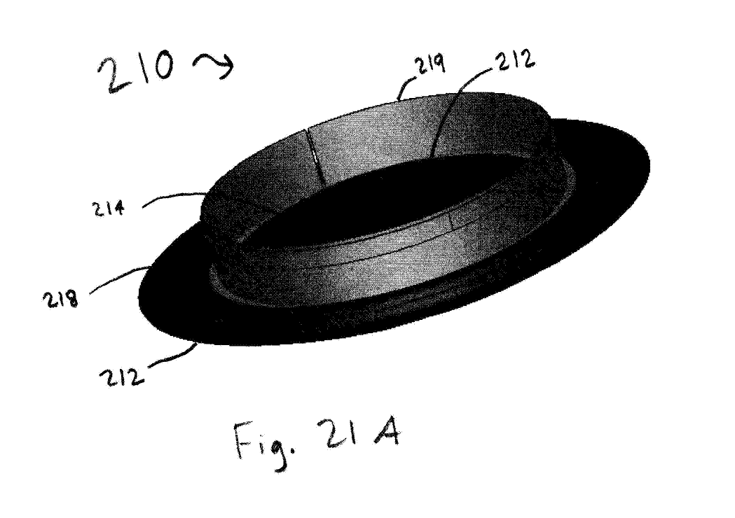

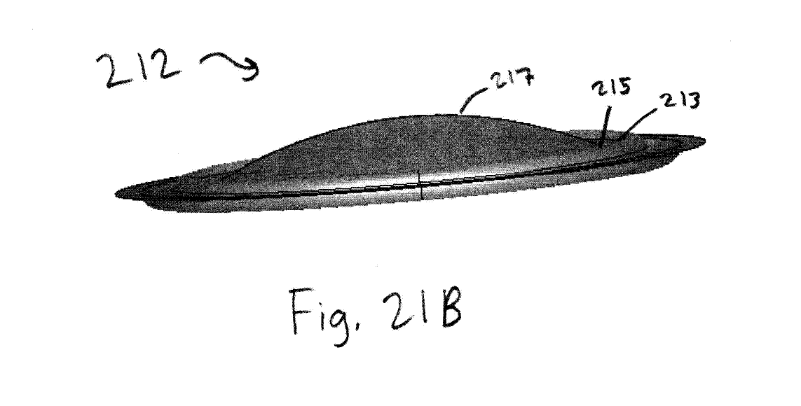

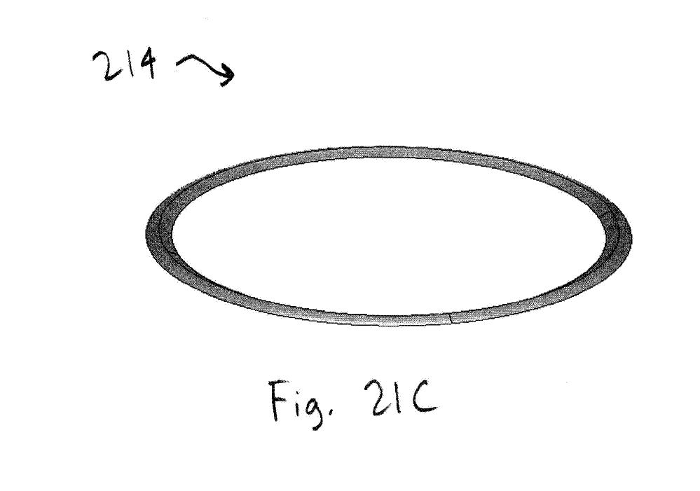

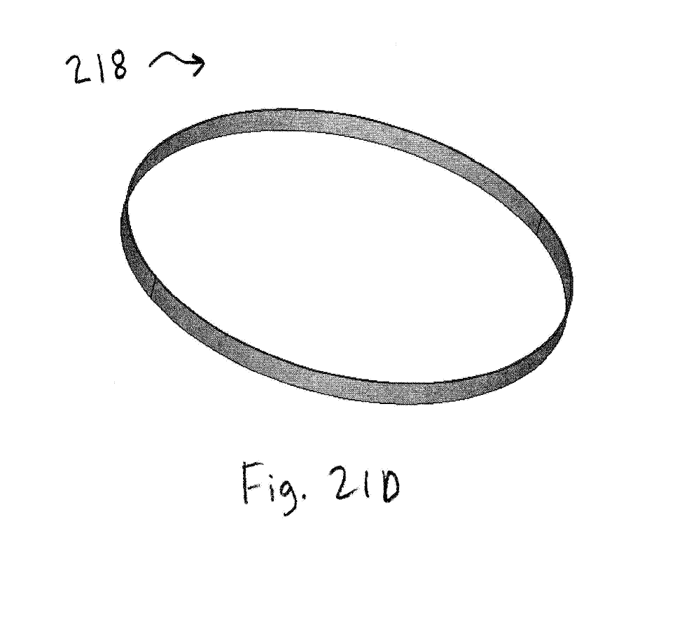

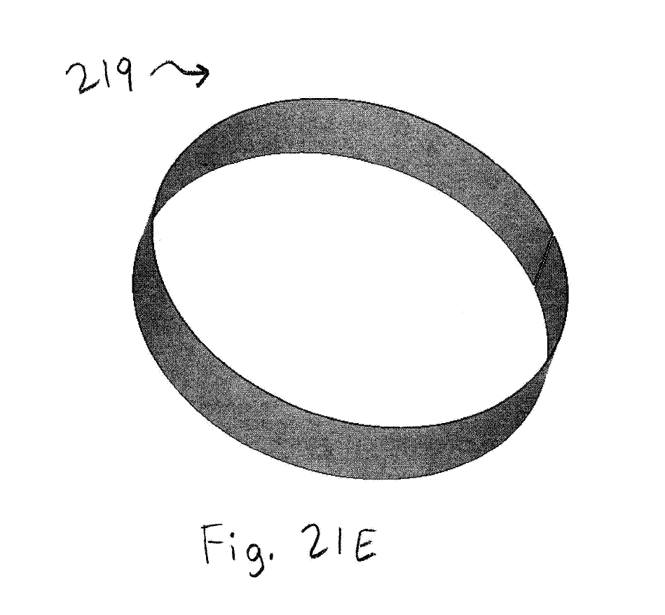

Embodiments according to the present disclosure can also comprise a variety of different component structures. For instance, reinforcement assemblies according to the present disclosure can combine otherwise separate components. Reinforcement assembly 210 includes one such structure, as displayed in FIG. 21A, wherein front suspension and dome are molded from the same component piece, such that they comprise a single component. FIG. 21B displays that this component is dome suspension structure 212. Reinforcement assembly 210 also comprises reinforcement ring 214, voice coil 218, and bobbin 219, each of which is displayed in FIGS. 21C-21E, respectively.

Dome suspension structure 212 is molded together as a single component, which can add to the structural integrity of the speaker driver. As shown in FIG. 21B, dome suspension structure 212 comprises dome center structure 217, trough 215, and edge 213. Other embodiments according to the present disclosure can comprise different component structures. For instance, a variety of different components can be molded together to increase the structural stability of the speaker driver. It is understood that embodiments according to the present disclosure can include any appropriate component structure, including but not limited to those component structures that improve the structural stability of the speaker driver.

It is understood that embodiments presented herein are meant to be exemplary. Embodiments of the present disclosure can comprise any combination of compatible features shown in the various figures, and these embodiments should not be limited to those expressly illustrated and discussed.

Although the present disclosure has been described in detail with reference to certain configurations thereof, other versions are possible. Therefore, the spirit and scope of the disclosure should not be limited to the versions described above.

The foregoing is intended to cover all modifications and alternative constructions falling within the spirit and scope of the disclosure as expressed in the appended claims, wherein no portion of the disclosure is intended, expressly or implicitly, to be dedicated to the public domain if not set forth in the claims.

1. A speaker driver, comprising:
a dome comprising a dome center structure and a dome edge, wherein said dome edge is angled differently from said dome center structure;
a trough at the intersection of said dome edge and said dome center structure; and
a reinforcement ring on said trough.

2. The speaker driver of claim 1, wherein said reinforcement ring increases the radial tensile strength of said dome.

3. The speaker driver of claim 2, wherein said reinforcement ring at least partially limits the radial movement of said dome edge.

4. The speaker driver of claim 2, wherein said reinforcement ring at least partially limits the axial movement of said dome center structure.

5. The speaker driver of claim 1, wherein said dome edge is angled inversely to said dome center structure.

6. The speaker driver of claim 5, wherein said dome edge angle is 45 degrees.

7. The speaker driver of claim 1, wherein said dome center structure comprises a catenary, spherical, parabolic, or conical shape.

8. The speaker driver of claim 1, wherein said reinforcement ring comprises an adhesive.

9. A method of forming a speaker driver, comprising:
constructing a dome comprising a dome center structure and a dome edge;
bending said dome edge at an angle different from said dome center structure, wherein said bending forms a trough at the intersection of said dome edge and said dome center structure;
injecting an adhesive in said trough; and
hardening said adhesive to form a reinforcement ring.

10. The method of claim 9, wherein said dome edge is angled inversely to said dome center structure.

11. The method of claim 10, wherein said dome edge angle is 45 degrees.

12. The method of claim 9, wherein said dome center structure comprises a catenary, spherical, parabolic, or conical shape.

13. The method of claim 9, wherein said reinforcement ring increases the radial tensile strength of said dome.

14. The method of claim 13, wherein said reinforcement ring at least partially limits the radial movement of said dome edge.

15. The method of claim 13, wherein said reinforcement ring at least partially limits the axial movement of said dome center structure.

16. A speaker driver, comprising:
a reinforcement assembly, comprising:
a dome comprising a dome center structure and a dome edge;
a reinforcement ring on said dome;
a front suspension on said dome;
a voice coil on said dome; and
a bobbin on said dome.

17. The speaker driver of claim 16, wherein said dome edge is angled differently from said dome center structure to form a trough at the intersection of said dome edge and said dome center structure.

18. The speaker driver of claim 16, wherein said reinforcement ring increases the radial tensile strength of said dome by at least partially limiting the radial movement of said dome edge.

19. The speaker driver of claim 16, wherein said reinforcement ring at least partially limits the axial movement of said dome center structure.

20. The speaker driver of claim 16, wherein said dome center structure comprises a catenary, spherical, parabolic, or conical shape.
